(19) United States
(12) Patent Application Publication
(10) Pub. No.: US 2021/0133904 A1
(43) Pub. Date: May 6, 2021

(54) SYSTEMS AND METHODS FOR INFIELD COLLECTION OF DIGITAL EVIDENCE

(71) Applicant: Magnet Forensics Inc., Waterloo (CA)

(72) Inventors: Jad John Saliba, Waterloo (CA); Tayfun Uzun, Waterloo (CA)

(21) Appl. No.: 17/028,206

(22) Filed: Sep. 22, 2020

Related U.S. Application Data
(60) Provisional application No. 62/929,431, filed on Nov. 1, 2019.

(51) Int. Cl. G06Q 50/26; G06Q 10/10; G06F 16/182; G06F 13/42

(52) U.S. Cl. CPC G06Q 50/26; G06Q 10/10; G06F 3/04847; G06F 13/4282; G06F 2213/0042; G06F 16/182

(57) ABSTRACT

A computer system and method for infield collection of digital evidence is provided. The computer system includes a communication interface for connecting the computer system to an evidence provider device and a processor configured to transfer digital evidence from the evidence provider device to the computer system by pulling media files from the evidence provider device onto the computer system, filtering the media files according to filtering criterion data, displaying thumbnails the filtered media files, receiving selection data indicating which of the displayed filtered media files is selected to be transferred, and copying the selected media files and media file metadata for the selected media files to the computer system. The computer system also includes a user input device which receives the filtering criterion data and selection data from a user and a display communicatively connected to the processor and which displays at least one output of the processor.

### Technical Field

The following relates generally to digital investigation tools, and more particularly to systems and methods for infield collection of digital evidence from consenting providers.

### INTRODUCTION

Since digital evidence is now a pervasive part of every investigation, it is becoming increasingly difficult for agencies to rely solely on their tech crime units to keep up with requests from the field. Police officers are faced with the challenge of asking victims and witnesses to turn over their phones and other mobile devices for weeks or months at a time. In some cases, officers are stuck waiting hours for their busy tech crime unit to arrive at the scene. Police agencies need a new way for non-technical officers to quickly acquire, report on, and share digital evidence in the field, such as at the scene of a crime.

The complexity of policing today is putting a strain on police-public trust. The volume of crimes involving digital evidence is rising. Key evidence is being left behind, making it harder to clear cases. Due to backlogs, digital forensics labs can't keep up with investigator requests.

One in four teens are receiving sexually explicit texts and content. One in twelve teens have had sexts or other content they sent shared without their permission.

Students are capturing digital evidence of school violence. Students are often unwilling to turn their phone over to the police to be held in the forensic lab backlog until a phone extraction can occur.

Collecting digital evidence from witnesses or victims is challenging due to logistics, time and technology. Time is the biggest challenge. Preparing a report for an incident with key evidence in a timely manner can be difficult. Due to backlogs, digital forensics labs can't keep up with requests from the frontline.

Victims of human trafficking are here today and gone tomorrow. They feel alone and are subjected to dangerous situations. Time is the biggest challenge. Quickly gathering the evidence and intelligence needed to build cases and keep victims safe can be challenging. Due to backlogs, digital forensics labs can't respond to human trafficking requests in a timely fashion.

Accordingly, there is a need for an improved system and method for digital evidence collection that overcomes at least some of the disadvantages of existing systems and methods.

### SUMMARY

A computer system for infield collection of digital evidence is provided. The computer system includes a communication interface for communicatively connecting the computer system to an evidence provider device. The evidence provider device is associated with an evidence provider. The computer system also includes a processor communicatively connected to the communication interface and configured to transfer digital evidence from the evidence provider device. The processor transfers digital evidence from the evidence provider device to the computer system by pulling a plurality of media files from the evidence provider device onto the computer system, filtering the plurality of media files according to filtering criterion data, displaying a thumbnail of each of the filtered media files, receiving selection data indicating which of the displayed filtered media files is selected to be transferred, and copying the selected media files and media file metadata for the selected media files to the computer system. The computer system also includes a user input device communicatively connected to the processor and configured to receive the filtering criterion data and selection data from a user and a display communicatively connected to the processor and configured to display at least one output of the processor.

The computer system may be a host device comprising a mobile computing device.

The computer system may include a host device comprising a mobile computing device communicatively connected to a remote server in a client-server relationship.

The processor may pull the selected media files and media file metadata data from the provider device via the Media Transfer Protocol.

The media file metadata may include forensic data.

The forensic data may include any one or more of a hash value and an original file path.

The media file metadata may include EXIF data.

The EXIF data may include any one or more of geolocation data and a timestamp.

The processor may be further configured to capture consent data from the evidence provider prior to transferring the digital evidence.

The consent data may include audio data or video data captured by a camera of the computer system.

The consent data may include a filled electronic consent form including electronic signature data provided by the evidence provider.

The evidence provider device may connect to the computer system via a USB On-The-Go format.

The provider device may connect to the host device via a USB cable.

The provider device may connect to the computer system via a WiFi direct hotspot hosted by the computer system.

The provider device may connect to the host device via an external website provided by the computer system, wherein the external website is configured to perform a cloud-based transfer of the digital evidence.

The processor may be further configured to generate an electronic case report describing the transferred digital evidence and including at least a portion of the media file metadata.

A method of collecting and reporting on digital evidence is also provided. The method includes connecting an evidence provider device to a host device, transferring digital evidence from the evidence provider device to the host device, and generating an electronic case report describing the transferred digital evidence and including at least a portion of the media file metadata. Transferring the digital evidence from the evidence provider device to the host device includes pulling a plurality of media files from the evidence provider device onto the host device, filtering the plurality of media files according to filtering criterion data, displaying a thumbnail of each of the filtered media files, receiving selection data indicating which of the displayed filtered media files is selected to be transferred, and copying the selected media files and media file metadata for the selected media files to the host device.

The method may also include capturing consent data from the evidence provider via the host device.

The consent data may include one or more of audio data, video data, and a filled electronic consent form including electronic signature data provided by the evidence provider.

The media file metadata may include any one or more of a hash value, an original file path, geolocation data, and a timestamp.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a visual inspection system, according to an embodiment;

FIG. 2 is a block diagram of a computing device of FIG. 1, according to an embodiment;

FIG. 3 is a block diagram of a computer system for capturing and reporting digital evidence, according to an embodiment;

FIG. 4 is a flowchart of a method of transferring digital evidence from a provider device to a host device, according to an embodiment;

FIG. 5 is a flowchart of a method of transferring digital evidence from a provider device to a host device, according to an embodiment;

FIG. 6 is a flowchart of a method of transferring digital evidence from a provider device to a host device, according to an embodiment;

FIG. 7 is a flowchart of a method of transferring digital evidence from a provider device to a host device, according to an embodiment;

FIG. 8 is a graphical interface of a system for infield digital evidence capture and reporting, according to an embodiment;

FIG. 9 is a graphical interface of a system for infield digital evidence capture and reporting, according to an embodiment;

FIG. 10 is a graphical interface of a system for infield digital evidence capture and reporting, according to an embodiment;

FIG. 11 is a graphical interface of a system for infield digital evidence capture and reporting, according to an embodiment;

FIG. 12 is a graphical interface of a system for infield digital evidence capture and reporting, according to an embodiment;

FIG. 13 is a graphical interface of a system for infield digital evidence capture and reporting, according to an embodiment;

FIGS. 14A-E are graphical interfaces of a system for infield digital evidence capture and reporting, according to an embodiment;

FIG. 15 is a graphical interface of a system for infield digital evidence capture and reporting, according to an embodiment;

FIG. 16 is a graphical interface of a system for infield digital evidence capture and reporting, according to an embodiment;

FIG. 17 is a graphical interface of a system for infield digital evidence capture and reporting, according to an embodiment;

FIG. 18 is a graphical interface of a system for infield digital evidence capture and reporting, according to an embodiment;

FIG. 19 is a graphical interface of a system for infield digital evidence capture and reporting, according to an embodiment;

FIG. 20 is a graphical interface of a system for infield digital evidence capture and reporting, according to an embodiment;

FIG. 21 is a graphical interface of a system for infield digital evidence capture and reporting, according to an embodiment;

FIG. 22 is a graphical interface of a system for infield digital evidence capture and reporting, according to an embodiment;

FIG. 23A-F are graphical interfaces of a system for infield digital evidence capture and reporting, according to an embodiment;

FIG. 24 is a graphical interface of a system for infield digital evidence capture and reporting, according to an embodiment;

FIG. 25 is a flowchart of a digital evidence workflow, according to an embodiment;

FIG. 26 is a flowchart of a digital evidence workflow, according to an embodiment;

FIG. 27 is a flowchart of a digital evidence workflow, according to an embodiment;

FIG. 28 is a flowchart of a digital evidence workflow, according to an embodiment;

FIG. 29 is a flowchart of a digital evidence workflow, according to an embodiment;

FIG. 30 is a flowchart of a digital evidence workflow, according to an embodiment;

FIG. 31 is a flowchart of a digital evidence workflow, according to an embodiment; and

FIG. 32 is a flowchart of a digital evidence workflow, according to an embodiment;

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to digital evidence management, and more particularly to systems and methods for capturing and reporting on digital evidence from consenting victims and witnesses in the field. The system and methods may be used by frontline law enforcement officers and investigators to improve digital evidence collection and reporting.

The system includes a host device comprising a mobile computing device such as a tablet. The host device is configured to run a digital evidence application. The host device and digital evidence application facilitate infield evidence capture and reporting. The host device is portable and captures and reports on digital evidence in a manner that allows its use in the field.

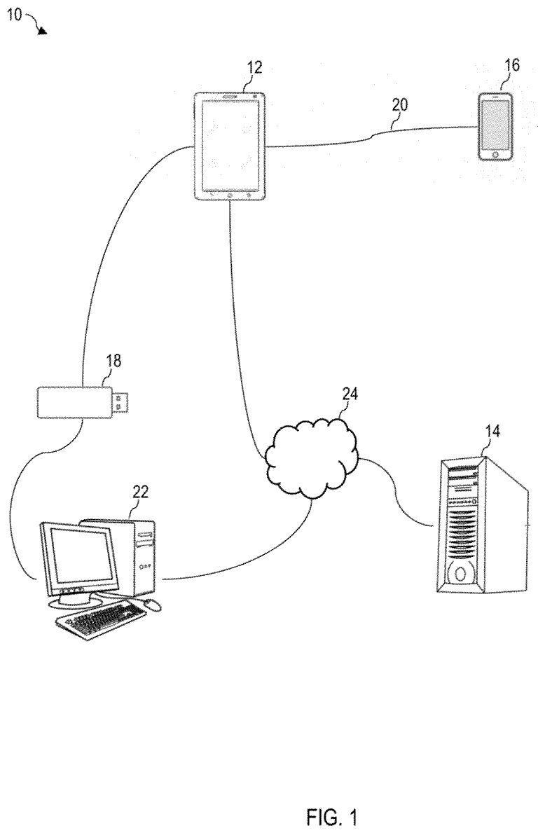

Referring now to FIG. 1, shown therein is a block diagram illustrating a digital evidence system 10, in accordance with an embodiment. The system includes a host device 12, which communicates with an evidence provider device 16 and a storage device 18. The system 10 also includes a workstation 22 which may receive digital evidence data from the storage device 18. The system 10 also includes an evidence management server 14, which can access and/or store case information provided by the host device 12. In some cases, the host device 12 may communicate directly with the server 14. In other cases, the server 14 may receive case information from the workstation 22 or storage device 18.

The host device 12 communicatively connects to the provider device 16 via wired connection 20. The wired connection may be a data transfer cable, such as a USB cable. In other embodiments, the host device 12 may communicatively connect to the provider device 16 via a wireless connection, such as WiFi.

Digital evidence data may be transferred between the provider device 16 and the host device 12 via the wired connection 20.

The system 10 captures, stores, and reports on digital evidence. The digital evidence may be a media file such as an image file, video file, or audio file. The media file may contain information that is relevant or potentially relevant to an alleged crime or other incident. For example, the media file may be an audio clip of an altercation between a suspect and a victim, a photo of a suspect, or a video of the alleged crime. The media file may be captured, for example, by a frontline officer or investigator using the host device 12 or by a witness, victim, or other individual. The media file may be a video interview or statement from a victim or witness collected by an officer or investigator.

In some cases, the system 10 may allow for the capture of digital evidence using the host device 12 without the need for the host device operator to possess or even touch the provider device 16. This may allow the evidence provider to maintain control of their device and not have to give the device up for an extended period of time (e.g. 3 weeks) which can be especially inconveniencing for a provider these days.

The system 10 automatically produces a standardized report on all digital evidence collected from the field that can be shared with prosecutors. The report may be a PDF report.

The system 10 can automatically produce a standardized evidence report on all digital evidence collected from the field using the system 10. The report may have a standardized format. The report may be a PDF report. In some cases, the standardized format may be designed to meet certain legal or evidentiary requirements. For example, in order for the evidence collected to be admissible, the evidence may need to meet certain requirements or be collected or presented in a particular way. By generating a report in a standardized format that meets one or more such requirements, the report can be shared with prosecuting attorneys in a format that is most effective or useful.

The host device 12 may be a purpose-built machine designed specifically for collecting and reporting on digital evidence. The host device 12 stores and runs a digital investigation application including computer-executable instructions that, when executed by a processor of the host device 12, cause the host device to capture and report on digital evidence.

The digital evidence may be captured by the host device 12 itself. Such evidence may be captured by taking a photo or video using a camera of the host device 12. In some cases, the evidence captured by the host device 12 may include a photo or video of a piece of evidence, such as a text messaging exchange, displayed on the evidence provider device 16. The digital investigation application may be configured to acquire, analyze, and share evidence from computers, mobile devices, the cloud, etc.

In an embodiment, the host device 12 is a tablet or other mobile computing device (e.g. mobile phone). The host device 12 may be controlled and operated by a frontline police officer, investigator, or the like. For example, the host device 12 may be stored in a police cruiser for use by an officer in the field.

The digital investigation application enables frontline police officers and investigators to capture and report on digital evidence from consenting victims and witnesses in the field.

In an embodiment, the host device 12 is a Microsoft Go Surface tablet.

In another embodiment, the host device 12 may be any computer or tablet powered by an operating system such as Windows 10, Android, iOS, or the like. The host device 12 may be which may be an existing mobile data terminal in a police cruiser.

Data integrity may be maintained by operating system security and IT controls (e.g. Microsoft Windows 10 security and IT controls).

The evidence provider device 16 is associated with an evidence provider. The evidence provider may be a witness to or victim of a potential crime. The provider device 16 stores the digital evidence, which may be a media file such as a photo or video. The digital evidence is transferred to or otherwise captured by the host device 12.

The provider device 16 may be a mobile computing device such as a mobile phone, tablet, digital camera, dashcam, SD card, USB, or the like.

The storage device 18 is a USB storage device. The digital evidence data can be transferred from the host device 12 to the storage device 18 by connecting the storage device 18 to the host device 12 by physical connection (e.g. plugging the USB device into the host device 12). In other embodiments, the storage device 18 may be communicatively connected to the host device 12 to facilitate data transfer without physically connecting the storage device 18 to the host device 12

In other embodiments, the storage device 18 may be any suitable type of storage device capable of receiving and storing digital evidence data transferred from the host device 12.

The digital evidence captured by the system 10 may be stored in an existing digital evidence management system, records management system (RMS), or the like.

The digital evidence management server 14 may include or interface with digital evidence and records management software configured to receive, manage, and store the digital evidence captured by the system 10.

The digital evidence management server 14 is connected to the host device 12 via network 24. The network 24 may be a wireless communications network, such as the Internet. In an embodiment, the host device 12 connects to the server 14 via WiFi. The host device 12 may connect to the server 14 via WiFi at a police station (e.g. upon the officer's return) or in the field such as via a mobile hotspot in the field or WiFi-enabled police cruiser.

The evidence management server 14 may be a cloud server which provides a cloud computing service (e.g. drop box in cloud). The server 14 may include an end user account for the cloud computing service (e.g. Azure cloud) that is associated with the user of the host device 12. The user of the host device may be an organization, such as a police department, or may be a specific officer or investigator. Cases generated using the host device 12 can be copied to an end user account of the server 14 (e.g. Azure cloud). Cloud storage using server 14 may allow efficient sharing of digital evidence with defense and prosecution. As well, storing cases at server 14 can move the cases off the host device 12 and onto the server 14 (e.g. into the cloud) which may provide safer long-term storage and free up space on the host device 12.

The server platforms 12 and 14, and devices 16, 22 may be a server computer, desktop computer, notebook computer, tablet, PDA, smartphone, or another computing device. The devices 12, 14, 16 may include a connection with the network 20 such as a wired or wireless connection to the Internet. In some cases, the network 20 may include other types of computer or telecommunication networks (e.g. Bluetooth, LoRa, NFC, etc.). The devices 12, 14, 16 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20.

Input device may include any device for entering information into device 12, 14, 16. For example, input device may be a keyboard, keypad, cursor-control device, touchscreen, camera, digital pen, stylus, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16 may include multiple of any one or more of processors, applications, software modules, second storage devices, network connections, input devices, output devices, and display devices.

Although devices 12, 14, 16 are described with various components, one skilled in the art will appreciate that the devices 12, 14, 16 may in some cases contain fewer, additional or different components. In addition, although aspects of an implementation of the devices 12, 14, 16 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16 and/or processor to perform a particular method.

Devices such as server platforms 12 and 14 and devices 16 can be described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16 may send information to the server platforms 12 and 14. For example, a user using the device 16 may manipulate one or more inputs (e.g. a mouse and a keyboard) to interact with a user interface displayed on a display of the device 16. Generally, the device may receive a user interface from the network 20 (e.g. in the form of a webpage). Alternatively, or in addition, a user interface may be stored locally at a device (e.g. a cache of a webpage or a mobile application).

Server platform 12 may be configured to receive a plurality of information, from each of the plurality of devices 16 and the server 14.

In response to receiving information, the server platform 12 may store the information in storage database. The storage may correspond with secondary storage of the devices 16 and the server 14. Generally, the storage database may be any suitable storage device such as a hard disk drive, a solid-state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The system 10 may provide various advantages over existing approaches to evidence collection and reporting.

The system 10 may provide simple evidence capture. The system 10 may allow witnesses and victims to share digital evidence easily and conveniently. The system 10 may provide quick and easy reporting for officers and investigators. The system 10 may provide an effective way to preserve fleeting evidence. The system 10 may provide secure collaboration by allowing sharing among colleagues (e.g. between officers and prosecutors), security, and a designated evidence repository for storing digital evidence.

The system 10 may empower officers to collect and report on fleeting evidence from consenting victims and witnesses while maintaining privacy and building trust with the public.

The system 10 may reduce report writing time, allowing officers to respond to more calls and spend more time in the community. Keep your officers in the community instead of spending time writing reports.

Using the system 10, officers can quickly and easily capture photo, video, and chat evidence with a camera of the host device 12 or by connecting the host device 12 to the victim or witness's mobile phone 16.

Many individuals may not be comfortable with letting the police go through their mobile device. The system 10 may build trust and maintain privacy with victims and witnesses by allowing the victim or witness to select specific photos, videos, and chats that are shared.

Getting witnesses and victims to consent to sharing evidence can be tough. The system 10 may improve chances of obtaining evidence by allowing the collection of evidence right at the scene instead of relying on victims and witnesses to hand over mobile devices to a digital evidence forensics lab.

The host device 12 may provide an easy-to-use interface and familiar operating system (e.g. Windows), allowing officers to pick-up the host device 12 and head to the field with minimal training.

Using the system 10, after collecting evidence from the scene, officers can quickly email the evidence report generated by the system 10 to prosecutors or upload both the digital evidence and evidence report into their RMS or digital evidence repository via the storage device 18 (e.g. USB).

The system 10 may leverage IT controls of the operating system platform such as password authentication, AD integration, and the like.

The system 10 may save officer time per call by simplifying report writing. The system 10 may help officers spend more time building trust in the community and allowing officers to take a more victim-centric approach to policing.

Many victims and witnesses to crimes often want to assist the police, and the system 10 may make it easier for them to cooperate and share critical digital evidence that can help keep communities safe.

The system 10 may have various applications for the collection of digital evidence such as general investigations and investigations where the collection of evidence and participation of witnesses and victims can be precarious such as child exploitation and bullying cases, human trafficking cases, and domestic violence cases.

The systems of the present disclosure may include design features that provide advantages over existing evidence management approaches.

The system may capture digital evidence data from an evidence provider device, such as a mobile device of a witness in a more efficient way.

The system may take less data. For example, the system may be configured to take a subset of media data from a provider device, which may reduce the amount of data which can reduce storage requirements and time sorting through irrelevant data searching for relevant.

The system may collect digital evidence in a forensically verifiable and evidentiarily acceptable way.

The system may generate a case report automatically that includes the captured digital evidence.

The system may provide real efficiencies to the processing of evidence. The system may do so by taking only targeted data from a provider device rather than more data than is necessary (e.g. some current methods take a whole mobile device and only read some data). Taking only useful data may increase speed of the process and decrease costs related to storage of data.

The system 10 may be used by a patrol officer. The system 10 may help officers produce standardized, professional reports of fleeting evidence from consenting victims and witnesses while maintaining privacy and building trust with the public. The system 10 may enable witnesses to share evidence, quickly and easily capture photo and video evidence, collect evidence at the scene, preserve evidence, and produce reports immediately. The system 10 may increase police service efficiency and reduce costs associated with digital evidence analysis and reporting. The system 10 may enhance public trust in police officers by enabling officers to help victims and collect evidence in a comfortable and professional manner. The system 10 may reduce time spent by officers creating reports, leaving more time for officers to spend in the community. The system 10 may allow frontline officers to perform simple data extractions instead of relying on costly digital examiners. The system may reduce officer report writing time by 30-60 minutes per occurrence. By reducing report writing time, the system 10 may enable officers to respond to more occurrences per shift. The system 10 may improve policing quality. The system 10 facilitates the capture of digital evidence immediately after an incident, when victims are most willing to cooperate with police. The system 10 can easily generate and present case reports describing the digital evidence to prosecutors and the accused, which may increase the chances of an early plea.

The system 10 may assist school resource officers in tackling cyber-bullying and illicit image sharing in schools by capturing digital evidence from consenting victims and witnesses. The system 10 may standardize and simplify evidence-based reporting on school incidents including cyber-bullying, assaults, and illicit image sharing. The system 10 may provide time savings by allowing on-scene evidence capture without requiring students to turn over their phones. The system 10 may reduce the dependency on digital forensic labs to capture picture and chat evidence. The system 10 may increase parent and student trust by building confidence with students and parents by providing a system that can help school resource officers and school officials to take actionable steps to resolve cyber bullying and illicit image sharing. The system 10 can be used and operated on-scene which allows witnesses and victims to keep possession of their devices and share the digital evidence that they want to share in a comfortable setting. The system 10 may also support Internet Crimes Against Children (ICAC) investigations, such as by collecting pictures and videos, along with their hashes, and sharing with ICAC databases such as Project VIC.

The system 10 may enable officers to effectively collect the digital evidence they need to help victims of crimes. The system 10 may help secure key evidence such as by quickly capturing and preserving evidence in the moment without requiring digital forensics assistance. Further, Witnesses and victims can become un-cooperative a few short hours after an incident and the system 10 allows a user to obtain evidence when it is available. The system 10 may provide time savings by reducing the dependency on the digital forensic lab to capture chat and picture evidence. The system may reduce report writing time significantly (e.g. by 30-60 minutes per occurrence). The system 10 may provide standardization in documentation by generating standardized easy to read reports for prosecutors and investigators containing digital evidence. The system 10 may enable officers to follow a consistent process which can maintain evidence chain of custody. The system 10 may enhance public trust. The public expects to see police in the community. By spending less time creating reports, the system 10 may allow officers to spend more time in the community building relationships. The system 10 may enhance public trust of officers by assisting officers to take a victim-centric approach to policing and make it easier to collect information needed to help the officers.

The system 10 may assist in human trafficking investigations. The system 10 may help officers produce standardized, professional reports of fleeting evidence from consenting victims and witnesses while maintaining privacy and building trust with the public. The system 10 may help protect victims by securing and reporting on digital evidence to help build solid cases. The system 10 may help secure key evidence, such as by quickly capturing and preserving evidence in the moment without requiring tech crime assistance. Witnesses and victims can become un-cooperative a few short hours after an incident, the system 10 may facilitate easy collection of evidence when it is available.

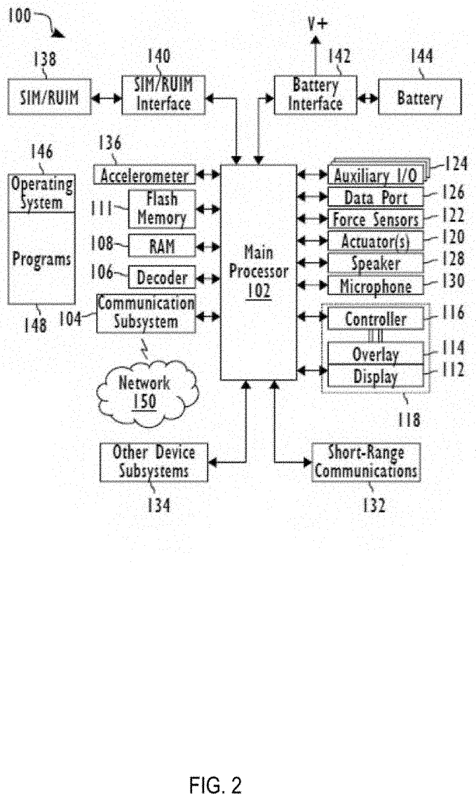

FIG. 2 shows a simplified block diagram of components of a device 100, such as a mobile device or portable electronic device. The device 100 may be, for example, any of devices 12, 14, 16, 18, of FIG. 1. The device 100 includes multiple components such as a processor 102 that controls the operations of the device 100. Communication functions, including data communications, voice communications, or both may be performed through a communication subsystem 104. Data received by the device 100 may be decompressed and decrypted by a decoder 106. The communication subsystem 104 may receive messages from and send messages to a wireless network 150.

The wireless network 150 may be any type of wireless network, including, but not limited to, data-centric wireless networks, voice-centric wireless networks, and dual-mode networks that support both voice and data communications.

The device 100 may be a battery-powered device and as shown includes a battery interface 142 for receiving one or more rechargeable batteries 144.

The processor 102 also interacts with additional subsystems such as a Random Access Memory (RAM) 108, a flash memory 110, a display 112 (e.g. with a touch-sensitive overlay 114 connected to an electronic controller 116 that together comprise a touch-sensitive display 118), an actuator assembly 120, one or more optional force sensors 122, an auxiliary input/output (I/O) subsystem 124, a data port 126, a speaker 128, a microphone 130, short-range communications systems 132 and other device subsystems 134.

In some embodiments, user-interaction with the graphical user interface may be performed through the touch-sensitive overlay 114. The processor 102 may interact with the touch-sensitive overlay 114 via the electronic controller 116. Information, such as text, characters, symbols, images, icons, and other items that may be displayed or rendered on a portable electronic device generated by the processor 102 may be displayed on the touch-sensitive display 118.

The processor 102 may also interact with an accelerometer 136 as shown in FIG. 1. The accelerometer 136 may be utilized for detecting direction of gravitational forces or gravity-induced reaction forces.

To identify a subscriber for network access according to the present embodiment, the device 100 may use a Subscriber Identity Module or a Removable User Identity Module (SIM/RUIM) card 138 inserted into a SIM/RUIM interface 140 for communication with a network (such as the wireless network 150). Alternatively, user identification information may be programmed into the flash memory 110 or performed using other techniques.

The device 100 also includes an operating system 146 and software components 148 that are executed by the processor 102 and which may be stored in a persistent data storage device such as the flash memory 110. Additional applications may be loaded onto the device 100 through the wireless network 150, the auxiliary I/O subsystem 124, the data port 126, the short-range communications subsystem 132, or any other suitable device subsystem 134.

For example, in use, a received signal such as a text message, an e-mail message, web page download, or other data may be processed by the communication subsystem 104 and input to the processor 102. The processor 102 then processes the received signal for output to the display 112 or alternatively to the auxiliary I/O subsystem 124. A subscriber may also compose data items, such as e-mail messages, for example, which may be transmitted over the wireless network 150 through the communication subsystem 104.

For voice communications, the overall operation of the portable electronic device 100 may be similar. The speaker 128 may output audible information converted from electrical signals, and the microphone 130 may convert audible information into electrical signals for processing.

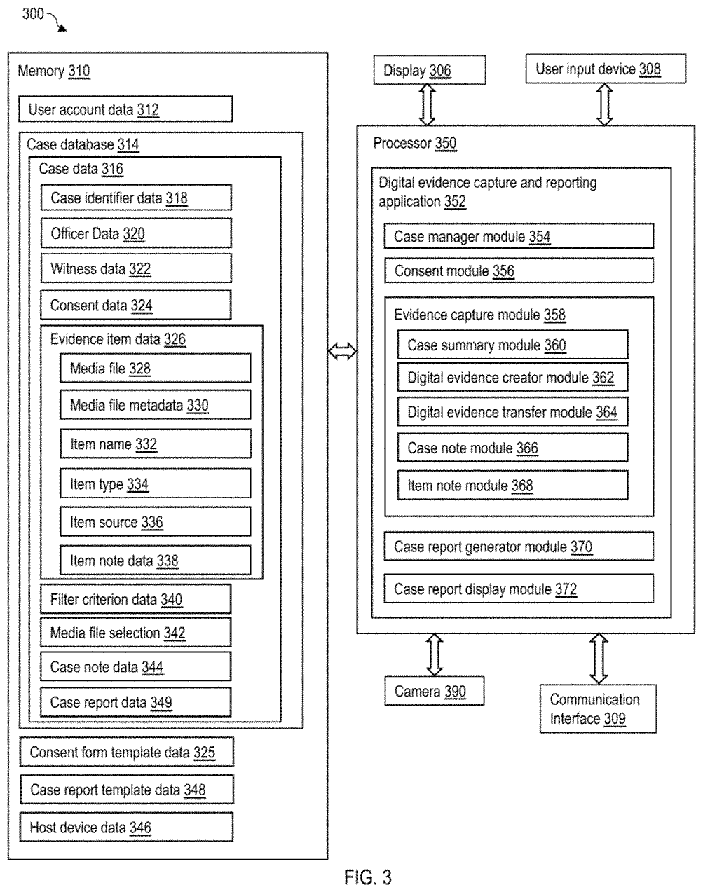

Referring now to FIG. 3, shown therein is a computer system 300 for infield digital evidence capture and reporting, according to an embodiment.

The system 300 can be used infield by a law enforcement officer, investigator, school resource officer, or the like to capture digital evidence and generate an electronic report describing the digital evidence.

The system 300 includes a memory 310 in communication with a processor 350.

The memory 310 may be stored at any one or more of a user device (e.g. host device 12 of FIG. 1) or a server.

The processor 350 may be located at any one or more of a user device (e.g. host device 12 of FIG. 1) or a server.

The system 300 also includes a display 306, a user input device 308, and a communication interface 309. The display 306, user input device 308, and communication interface 309 are in communication with the processor 350.

The display 306 is configured to display various data generated by the system to a user via one or more graphical user interfaces implemented by the processor 350.

The user input device 308 is configured to receive user input and generate user input data therefrom that can be processed by the processor 350. The user input device 308 may include a touchscreen display or the like. The user input device 308 facilitates user interaction with the one or more graphical user interfaces outputted at the display 306.

The communication device 309 facilitates the transfer of data between the system 300 and an external device, such as provider device 16. The communication interface 309 may use one or more protocols for data transfer such as USB or WiFi.

The processor 312 includes a digital evidence capture and reporting application 352.

The application 352 captures, manages, and reports on digital evidence.

The digital evidence capture and reporting application 352 includes a plurality of modules comprising computer-executable instructions that, when executed by the processor 350, cause the application 352, and thus the system 300, to perform the various digital evidence capture, storage, and reporting functions described herein.

In an embodiment, the application 352 is a non-web-based application executing on the host device 12.

In another embodiment, the application is a web-based application partially executing on the host device 12 and partially executing on a remote server communicatively connected to the host device 12 via a network, such as the Internet. In such an embodiment, the host device 12 may act as a client and the remote server as a server in a server-client relationship with the host device 12 including client-side software components and the server including server-side software components.

The memory 310 stores user account data 312. The user account data 312 describes a user account and may include a username and password. Various data stored in the memory 310 may be linked to the user account 312 to provider user-based access to data stored in the system 300.

User accounts may be assigned at the officer-level, department level, organization-level, etc. For example, the user account may be an officer account having an officer-specific username and password. In another example, the user account may be a department account having a department-specific username and password where multiple officers can access and use the account.

The memory 310 stores a case database 314. The case database 314 stores case data 316.

As used herein, a “case” is a digital representation in the system 300 of a specific occurrence or incident, such as a potential crime, that requires consideration or investigation by law enforcement or other authorities. Each case is represented in the system 300 by case data 316.

The case data 316 includes case identifier data 318, which may be a case number or other unique identifier. The case identifier data 318 may be used to link all data specific to a given case in the case database 314.

The application 352 includes a case manager module 354.

The case manager module 354 controls the creation, storage, and management of cases in the system 300.

The case manager module 354 may be configured to create a case in in the case database 314 in response to a user input received at the user input device 308. The user input may include the case identifier data 318. The user input may also include officer data 320 and evidence provider data 322. The officer data 320 may include an officer name and an officer badge number. The evidence provider data 322 may include an evidence provider name. The officer data 320 and evidence provider data 322 are stored in memory 310.

The case manager module 354 is configured to implement a case management graphical user interface that can be displayed via the display 306. The case management interface may display certain case data 316 from each case linked to the user account 312. Displayed case data may include case identifier data 318 and officer data 320.

The case manager module 354 is configured to copy case data 316 to an external storage device, such as a USB, in response to a user input received at the user input device 308.

The case manager module 352 is also configured to delete case data 316 in response to a user input received at the user input device 308.

The application 316 includes a consent module 356.

The consent module 356 is configured to capture consent from an evidence provider to the collection of content off the provider's electronic device. The consent is captured and stored in memory 310 as consent data 324. The consent may be written consent or oral consent.

The consent module 356 implements a graphical user interface for receiving consent that can be displayed via the display 306.

In an embodiment, the consent module 356 is configured to retrieve and display consent form template data 325, which is stored in memory 310. The consent form template data 325 includes a fillable electronic consent form for obtaining consent from an evidence provider.

The consent module 356 may be configured to generate consent data 324 in response to a user input received at the user input device 308. The consent data 324 may be a filled-out version of the consent form template 325. The user input received by the system 300 may include data inputted into input fields in the displayed consent form template 325, such as names and electronic signatures of an evidence provider and an officer (collecting the evidence).

In another embodiment, the consent module 356 may be configured to capture audio and/or video of consent, for example via camera 390, which can be stored as consent data 324.

The application 316 includes an evidence capture module 358.

The evidence capture module 358 is configured to capture and manage evidence item data 326. The evidence item data 326 describes a digital evidence item, such as a photo or video. A digital evidence item (or evidence item) is a discrete piece of digital evidence such as a media file (e.g. image, video). Each digital evidence item is stored in memory 310 as evidence item data 326.

The evidence item data 326 includes a media file 328. The media file 328 may be an image file, an audio file, or a video file.

The evidence item data 326 includes media file metadata 330. Media file metadata 330 may include any one or more of a file size, a file name, a creation timestamp, a last modified timestamp, a source location, and a hash value. The media file metadata 330 may also include EXIF data for media. The EXIF data may include GPS coordinates (i.e. longitude, latitude), make, model of camera, etc.

The evidence item data 326 also includes an item name 332, an item type 334, and an item source 336. The item type 334 describes the type of media file, such as a photo or video. The item source 336 includes the source device from which the media file 328 was obtained.

The evidence item data 326 also includes item note data 338. Item note data 338 includes one or more text notes which provide context for the evidence item and its relevance to the case.

The evidence capture module 358 includes a case summary module 360. The case summary module is configured to provide a summary of digital evidence items added to a given case using the system 300. The case summary module may retrieve certain evidence item data 326, such as an item name 332 and an item type 334, for a case and display the retrieved evidence item data 326 via the display 306.

The evidence capture module 358 includes a digital evidence creator module 362.

The digital evidence creator module 362 is configured to generate a digital evidence item using the host device 12. The digital evidence item includes a media file 328 such as an image file, audio file, or video file.

The digital evidence creator module 362 is configured to access a camera 390 of the host device 12 to capture the digital evidence item. The camera 390 is located at the host device 12. The digital evidence item comprising the generated media file 328 is stored in memory 310 as evidence item data 326.

The digital evidence creator module 362 may present a “frame” overlay on a viewfinder of the camera 390 to help align and stabilize photos of provider device screens.

The digital evidence creator model 362 also captures media file metadata 328 for the media file 328.

The evidence capture module 358 includes a digital evidence transfer module 364.

The digital evidence transfer module 364 is configured to collect digital evidence from the provider device 16 onto the host device 12. The collection may include copying the digital evidence onto the host device 12.

The digital evidence transfer module 364 transfers the digital evidence via a data transfer protocol, such as USB or WiFi.

In particular, the digital evidence transfer module 364 collects a media file 328 and media file metadata 330 from the connected provider device 16. The digital evidence transfer module 364 may logically copy the data 328, 330 from the provider device, preserving the meta-data including timestamps and embedded EXIF data from media.

Advantageously, the digital evidence transfer module 356 is configured to transfer the digital evidence from the provider device 16 to the host device 12 in a secure and forensically acceptable manner without the need for the provider device 16 to ever leave the possession of the provider.

The collected media file 328 and medial file metadata 330 are stored in the memory 310 as evidence item data 326.

The digital evidence transfer module 364 may be configured to pull all media files (and metadata) from the provider device 16 and intelligently filter out the items that do not meet a filter criterion (e.g. a data/time range). The filter criterion is provided to the system 300 as user input via the user input device 308 using a graphical interface of the system 300 and stored in memory 310 as filter criterion data 340. The media that is filtered out according to the filter criterion data 340 is not stored on the host device 12.

In an embodiment, the digital evidence transfer module 364 uses the MTP protocol to collect thumbnails of all media from the provider device 16. The transfer module 364 filters out thumbnails not meeting the filter criterion data 340. Collected thumbnails meeting the filter criterion data 340 are displayed to the user via the display 306.

The user may then select, using the user input device 308, which of the displayed thumbnails are media files 328 that can be transferred to the host device 12. The selected files are stored in memory 310 as media file selection data 342.

The digital evidence transfer module 364 may then logically copy media files 328 according to the media file selection data 342. Copying may include copying the media file 328 and media file metadata 330.

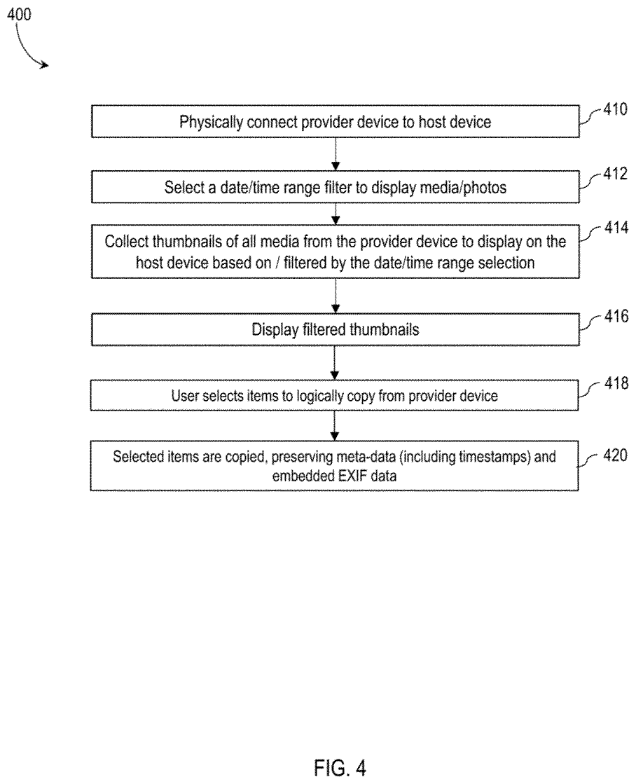

Referring now to FIGS. 4 to 7, shown therein are various methods of transferring a digital evidence item from a provider device (e.g. provider device 16 of FIG. 1) to a host device running a digital evidence application (e.g. host device 12 of FIG. 1 running digital evidence application 316 of FIG. 3), according to embodiments of the present disclosure.

The methods of FIGS. 4 to 7 can be implemented by the system 300 of FIG. 3, and in particular by the digital evidence transfer module 364, to transfer a digital evidence item, such as media file 328, that is stored on the provider device 16 to the host device 12.

In the embodiments described in FIGS. 4 to 7, the digital evidence item being transferred is a digital image file. In variations, the digital evidence item to be transferred may be one or media items of one or more types (e.g. photos, video).

Advantageously, the methods of transfer can be implemented without the provider device 16 ever going into the hands of the host device operator.

Referring now to FIG. 4, shown therein is a method 400 of transferring a digital evidence item from the provider device 16 to the host device 12 using a media transfer protocol (MTP) approach, according to an embodiment.

The method 400 uses a physical connection between the provider device 16 and the host device 12 and MTP to transfer the digital evidence item between the physically connected devices 12, 16.

MTP is a communications protocol that allows media files to be transferred atomically to and from portable devices. The main purpose of this protocol is to allow only the transfer of media files and associated metadata to and from portable devices, one transfer function, in or out, at a time. It does not support operations such as open, edit and modify. A main reason for using MTP rather than, for example, the USB mass-storage device class (MSC) is that the latter operates at the granularity of a mass storage device block (usually in practice, a FAT block), rather than at the logical file level. In other words, the USB mass storage class is designed to give a host computer undifferentiated access to bulk mass storage, such as compact flash, rather than to a file system, which might be safely shared with the target device (except for specific files which the host might be modifying/accessing). MTP and PTP specifically overcome this issue by making the unit of managed storage a local file rather than an entire (possibly very large) unit of mass storage at the block level. In this way, MTP works like a transactional file system, where either the entire file is written/read or nothing.

At 410, a user, such as an operator of the host device 16, physically connects the provider device 16 storing the image. The user may be a law enforcement officer. This may include connecting a USB cable or the like to both the host device 12 and the provider device 16.

At 412, the user selects a date filter to apply to the images on the provider device 16.

The date filter can be used to view pictures and video from a specified date range only. The date filter may be, for example, all dates, last 12 hours, last 24 hours, last 48 hours, last 7 days, or custom date range.

At 414, thumbnails of filtered photos are pulled from the provider device 16 and displayed on the host device 12.

At 416, the filtered thumbnails are displayed.

At 418, the user selects items via the displayed thumbnails to logically copy from the provider device 16.

At 420, the selected items are copied. The copying process preserves metadata from the files including timestamps and embedded EXIF data. Such metadata may be important to the collection of digital evidence in a forensically acceptable manner.

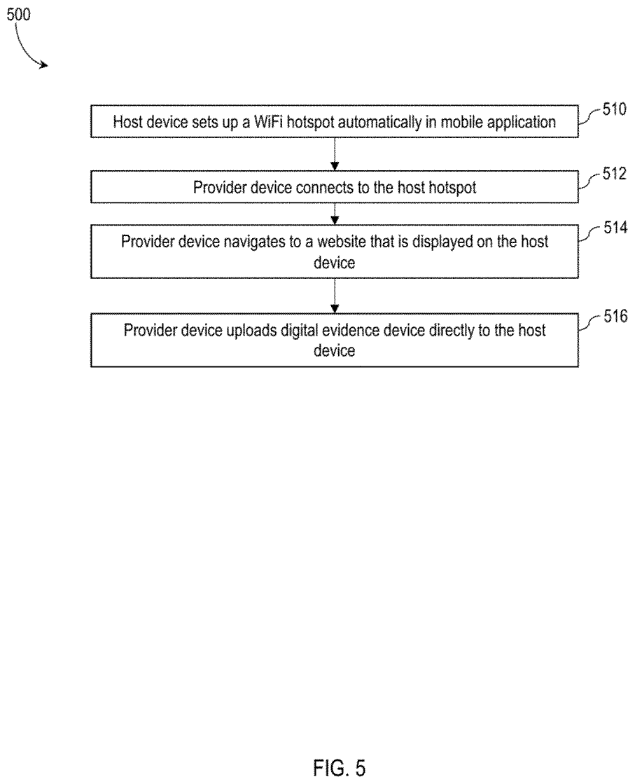

Referring now to FIG. 5, shown therein is a method 500 of transferring a digital evidence item from the provider device 16 to the host device 12 using a WiFi direct hotspot transfer approach, according to an embodiment.

Advantageously, the method 500 does not need the Internet to conduct the transfer and may be particularly suitable to infield data transfer.

Wi-Fi Direct is a WiFi standard that enables devices to connect and share data with each other without requiring an external wireless access point or the Internet.

In another embodiment, the host device 12 communicatively connects to the provider device 16 via a WiFi direct hotspot. The provider device 16 transfers data via the WiFi direct hotspot.

At 510, the host device 12 sets up a host WiFi hotspot automatically using the digital evidence application 316.

The host device 12 is manually assigned to host the network and the provider device 16 manually joins the hosted network.

At 512, the provider device 16 connects to the host hotspot. This may include the user of the provider device 16 manually connecting to the host hotspot using a user interface of the provider device for managing provider device connections.

At 514, the provider device 16 navigates to a website that is displayed on a screen of the host device 12. This may include the user of the provider device opening a web browser on the provider device 16 and entering a URL into the web browser based on what is displayed on the host device 12.

Upon submitting the URL, the web browser on the provider device 16 displays the website.

At 516, using a user interface provider at the website, the provider device (via provider input) can upload a digital evidence item directly to the host device 12. This may include, for example, the provider selecting an upload option and then selecting one or more media files to transfer to the host device 12.

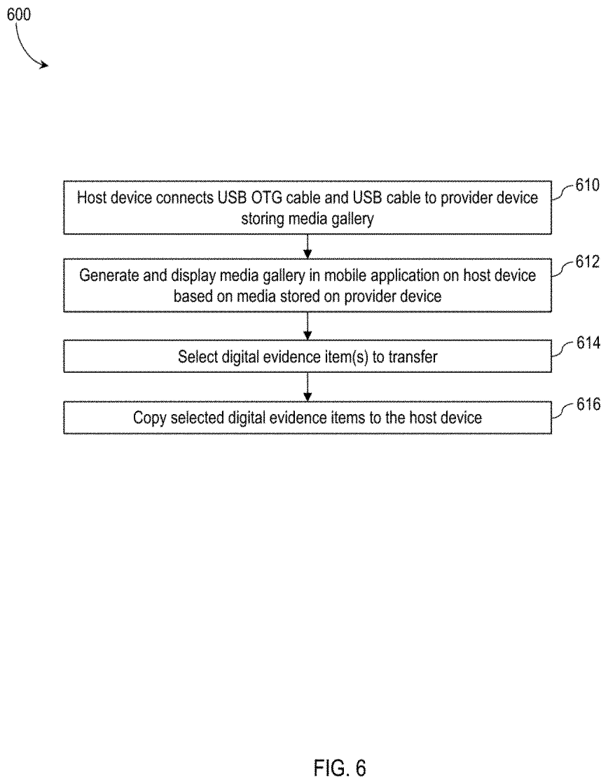

Referring now to FIG. 6, shown therein is a method 600 of transferring a digital evidence item from the provider device 16 to the host device 12 using a USB OTG transfer approach, according to an embodiment.

The method 600 uses a physical connection between the provider device 16 and the host device 12 and USB OTG to transfer the digital evidence item between the physically connected devices.

USB On-The-Go (USB OTG) is a specification that allows USB devices, such as tablets or smartphones, to act as a host, allowing other USB devices, such as USB flash drives, digital cameras, mice or keyboards, to be attached to them. Use of USB OTG allows those devices to switch back and forth between the roles of host and device. A mobile phone may read from removable media as the host device but present itself as a USB Mass Storage Device when connected to a host computer. USB OTG introduces the concept of a device performing both master and slave roles. Whenever two USB devices are connected and one of them is a USB OTG device, they establish a communication link. The device controlling the link is called the master or host, while the other is called the slave or peripheral. USB OTG defines two roles for devices: OTG A-device and OTG B-device, specifying which side supplies power to the link, and which initially is the host. The OTG A-device is a power supplier, and an OTG B-device is a power consumer. In the default link configuration, the A-device acts as a USB host with the B-device acting as a USB peripheral. The host and peripheral modes may be exchanged later by using Host Negotiation Protocol (HNP).

At 610, the host device 12 is physically connected to the provider device 16 via a USB OTG cable.

At 612, the system 300 generates and displays the media gallery in a mobile application on host device 12 based on media stored on provider device 16.

At 614, the system 300 receives selection data indicating items for transfer.

At 616, the system 300 copies selected items to the host device 12.

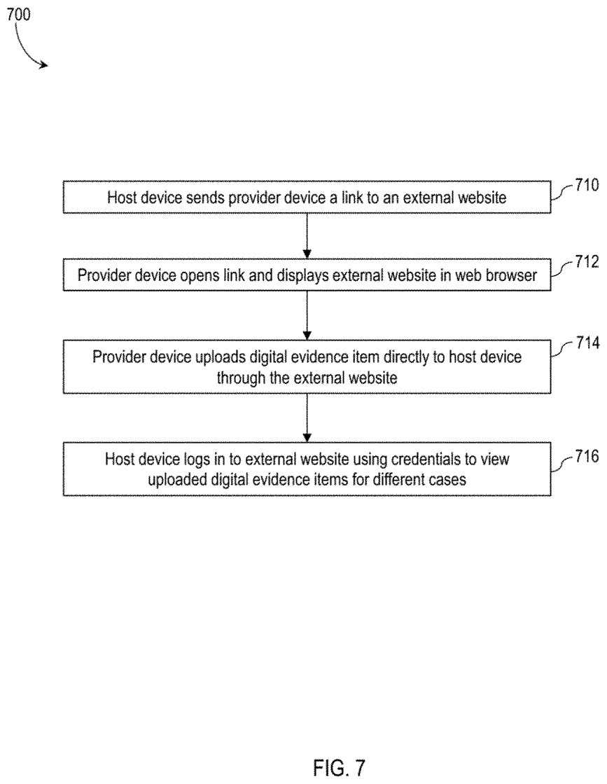

Referring now to FIG. 7, shown therein is a method 700 of transferring a digital evidence item from the provider device 16 to the host device 12 using a cloud-based evidence transfer approach, according to an embodiment.

In another embodiment, the provider device 16 transfers digital evidence data to the host device 12 via a cloud-based evidence transfer.

At 710, the host device 12 sends the provider device 16 a link to an external website.

At 712, the provider device 16 opens the link and displays the external website in a web browser.

At 714, the provider device 16 uploads a digital evidence item (e.g. media file 328) directly to host device 12 through the external website.

At 716, the host device 12 can log in to the external website to see uploads related to specific cases including those uploads from the provider device 16.

Referring again to FIG. 3, the evidence capture module 358 also includes a case note module 366.

The case note module 366 receives and stores case note data 344. The case note data 344 includes one or more text notes which provide context or descriptive information about the case for which digital evidence is being collected.

The case note module 366 may implement a case note graphical interface, which is displayed at the display 306. The interface includes one or more input fields for receiving text input of a case note. The text input is provided to the system 300 via the user input device 308. The received text input is stored as case note data 344 in memory 310.

The evidence capture module 358 also includes an item note module 368.

The item note module 368 receives and stores item note data 346. The item note data 346 includes one or more text notes which provide context or descriptive information about a given evidence item (i.e. media file 328).

The item note module 368 may implement an item note graphical interface, which is displayed at the display 306. The interface includes one or more input fields for receiving text input of an item note. The text input is provided to the system 300 via the user input device 308. The received text input is stored as item note data 346 in memory 310.

The memory 310 also stores host device data 346. The host device data 346 includes information about the host device 16. The host device data 346 may be used to identify the host device 16 responsible for capturing a given media file 328.

The host device data 346 may include any one or more of a device name, a device make, a device model, a device operating system (OS), and a device identifier. The device identifier may be a unique code including an alphanumeric string that can be used to identity the host device 16.

The digital evidence capture and reporting application 352 also includes a case report generator module 370.

The report generator module 370 is configured to generate a case report in an electronic file format (such as PDF) using the case data 316 and a case report template data 348.

The case report is stored in memory 310 as case report data 349.

The case report template data 320 includes a case report template that can be populated for a given case using the case data 316. In particular, the case report template may include a plurality of predefined fields for receiving certain case data 316. For example, the report template may include predefined fields for receiving case indentifer data 318, consent data 324, evidence item data 326, and case note data 344.

The case report template data 320 may also include data and instructions for rendering the populated case report template (i.e. the case report). The case report template data 320 may include a description of the case report template including text, fonts, vector graphics, raster images, formatting data, and other information needed to display the case report template when filled with the case data 316.

In an embodiment, the report generator module 370 creates a PDF report via a PDF generation library. The PDF report is stored as case report data 349.

The PDF report may include a title page with boilerplate information about the case including a case or occurrence number, an officer name, an officer badge number, a date/time of report, and devices analyzed.

The PDF report may also include a signed and filled out PDF consent form.

The PDF report may include EXIF data extracted from media files including a camera make and model, geolocation data, and timestamps of the media file 328.

The PDF report may include file metadata 330 from media files 328. The file metadata 330 may include a date of creation and a date modified.

The PDF report may include forensic data for each media file 328. The forensic data may include file hashes in MD5 and SHA1. The forensic data may include an original file path on the provider device 16. The forensic data is stored in memory 310 as media file metadata 330.

The PDF report may also include a forensic nomenclature glossary to explain complex terms.

The application 352 includes a case report display module 372.

The case report display module 372 is configured to retrieve the case report data from memory 310 and display the case report data 349 via the display 306.

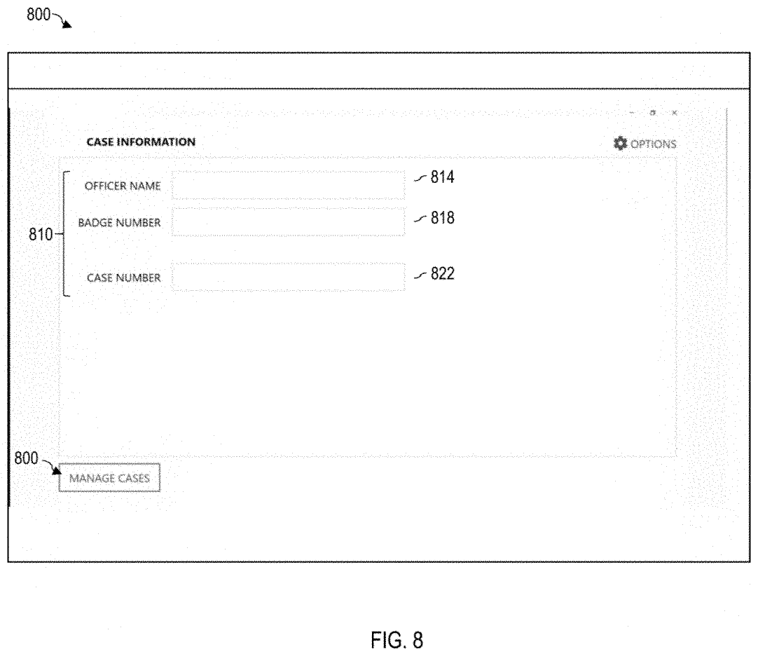

Referring now to FIGS. 8 to 24, shown therein are example graphical interface screens according to an embodiment of the present disclosure.

The graphical interfaces of FIGS. 8 to 24 may be implemented by the digital evidence application 316 of FIG. 3. The graphical interfaces include one or more software modules comprising computer executable instructions that, when executed by a processor, cause the system to display the graphical interfaces and provide the various functionalities provided thereby and described below.

The graphical interfaces of FIGS. 8 to 24 may be displayed at a display of the host device 16 (e.g. display 306 of FIG. 3). Generally, the graphical interfaces of FIGS. 8 to 24 can be used to display certain data stored by the system 10 to the user and receive certain data as input from the user via the user's interaction with the interfaces. The received input data is stored by the system 10.

In a particular embodiment, the system 300 may be configured to present the graphical interfaces of FIGS. 8 to 24 in sequential order as part of a digital evidence collection workflow.

Referring now to FIG. 8, shown therein is a graphical interface 800 according to an embodiment of the system 300. The graphical interface 800 can be used to input case data 810.

At 814, the user can input and the host device 16 receives officer name data.

At 818, the user can input and the host device 16 receives badge number data. The badge number data may be the badge number of an officer using the system.

At 822, the user can input and the host device 16 receives case identifier data. The case identifier data includes a case identifier, such as a case number, that can be used to identify a particular case (i.e. incident).

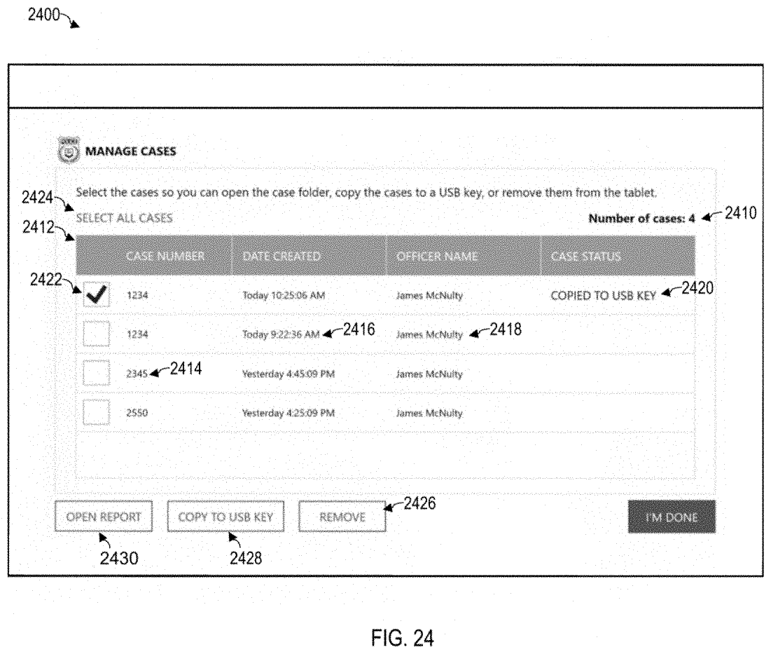

At 826, the user may select a “manage cases” icon, which may cause the system to launch and display a case management interface, such as graphical interface 2400 of FIG. 24.

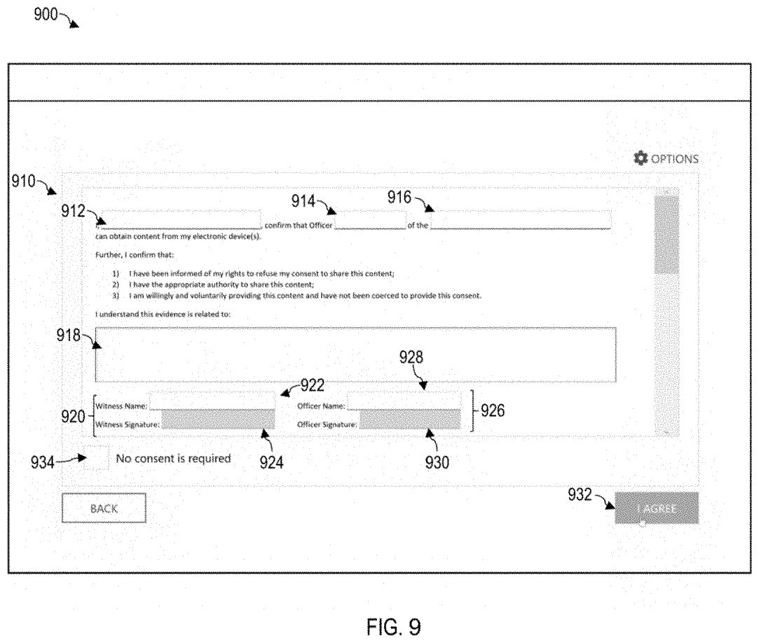

Referring now to FIG. 9, shown therein is a graphical interface 900 according to an embodiment of the system 300.

The graphical interface 900 can be used to implement a consent interface. Users of the interface 900 may include an evidence provider and an evidence collector (i.e. an operator of the host device 12).

The interface 900 is configured to display a consent form template 910. The consent form template 910 may be a fillable-type form including a plurality of input fields receptive to user input and which can be used to store various input data provided by the user. For example, the input fields may be configured to receive a text input delivered via a keypad or touchscreen. In an embodiment, the system 300 may store a plurality of consent form templates 325 in memory 310 and a user may select from the plurality of template options.

The interface 900 is also configured to receive input data from the user. The received input data represents consent provided by the evidence provider to the collection of content from the provider's electronic device (e.g. provider device 16). The received input data may be stored in the system 10 as consent data. The consent data may include a filled version of the consent form template 910 including the input data. The mechanism by which the user provides input data to the form and by which the system 300 receives such input data may vary based on the type of form stored and displayed by the system 300 and the rules for filling out such form. For example, different agencies may use different forms, which may be stored and displayed by the system 300 and receive input data from the user in different ways. Further, agencies may load in multiple consent forms of their own with custom fields to the system 300.

At 912, the user can input and the system receives provider name data. The provider name data includes the name of the evidence provider for which consent is being obtained.

At 914, the user can input and the system receives officer name data. The officer name data includes the name of the evidence collector, which in this case is a police officer.

At 916, the user can input and the system receives department name data. The department name data includes the name of the organization for which the evidence collector works, which in this case is a police department.

At 918, the user can input and the system receives consent context data. The consent context data includes descriptive information, such as a text note, providing context for the collection of evidence. The context may be descriptive information about an incident (e.g. “assault at Morty's Pub”).

At 920, the user can input and the system receives witness consent data including a witness name, which can be input and received at 922, and witness signature data, which can be input and received at 924.

At 926, the user can input and the system receives officer witness data including an officer name, which can be input and received at 928, and an officer signature data, which can be input and received at 930.

The signature data fields 924, 930 may be configured to receive and store an electronic signature via finger signing or signing via a touchscreen implement such as a stylus.

In some cases, selecting (such as by tapping) the signature data fields 924, 930 may open an electronic signature interface (e.g. interface 1000 described below) for providing the signature data.

At 932, the user can select “I agree” which confirms the consent information provided in the form and submits and stores the input data as consent data.

If no consent is required (for example if consent for the witness has been previously provided to and stored by the system 10), the user may select a “no consent required” checkbox 934, which may cause the system 10 to bypass the provision of consent data.

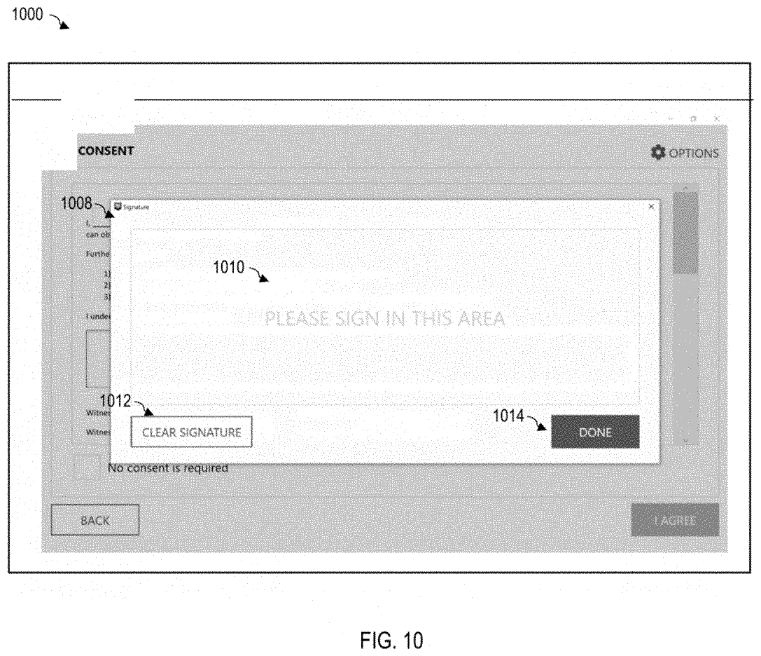

Referring now to FIG. 10, shown therein is a graphical interface 1000, according to an embodiment of the system 10.

The interface 1000 can be used to implement an electronic signature interface for receiving the signature data at input fields 924, 930 of FIG. 9. The interface 1000 may be displayed as a popup window 1008 in the interface 900 of FIG. 9.

At 1010, electronic signature data can be input by the user and received by the system. The user can provide their signature via a touchscreen interaction with the display at the field, such as via finger signing or using a touchscreen implement such as a stylus.

At 1012, the user can select to clear the signature provided, for example to redo the signature.

At 1014, the user can select “done”. By selecting the “done” icon, the electronic signature data provided to field 1010 is submitted and stored by the system. The popup window 1008 may be closed by the system 10.

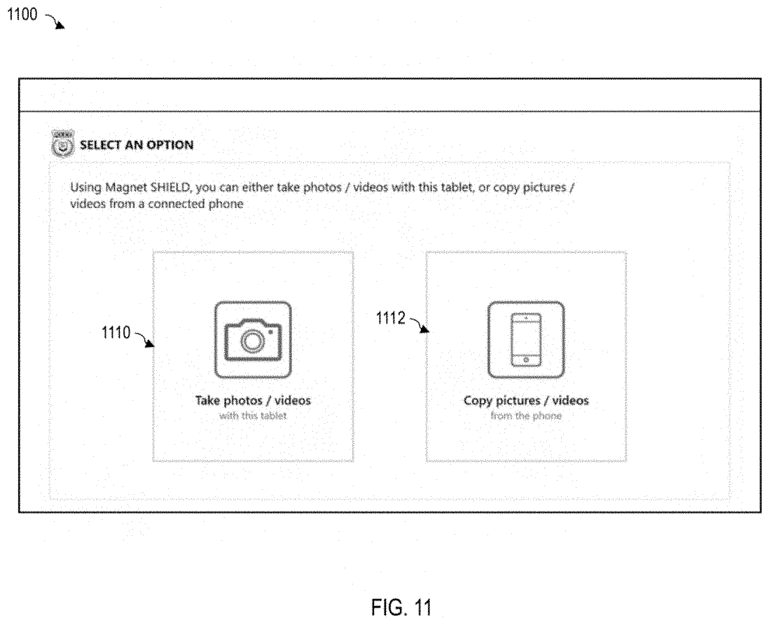

Referring now to FIG. 11, shown therein is a graphical interface 1100, according to an embodiment of the system 10.

The graphical interface 1100 can be used to implement a capture method selection interface. The interface 1100 may be used to input a capture method selection.

At 1110, a user can input and the system receives a digital evidence creator selection. Receipt of the evidence creator selection may cause the system to implement a digital evidence creator workflow, which may be implemented by the digital evidence creator module 362 of FIG. 3.

For example, by selecting 1110, the system may implement a workflow which allows the user to take photos or videos with the host device 12.

At 1112, a user can input and the system receives a digital evidence transfer selection. Receipt of the evidence transfer selection may cause the system to implement a digital evidence transfer workflow, which may be implemented by the digital evidence transfer module 364 of FIG. 3.

For example, by selecting 1112, the system may implement a workflow which allows the user to copy pictures or videos from a provider device 16 to the host device 16.

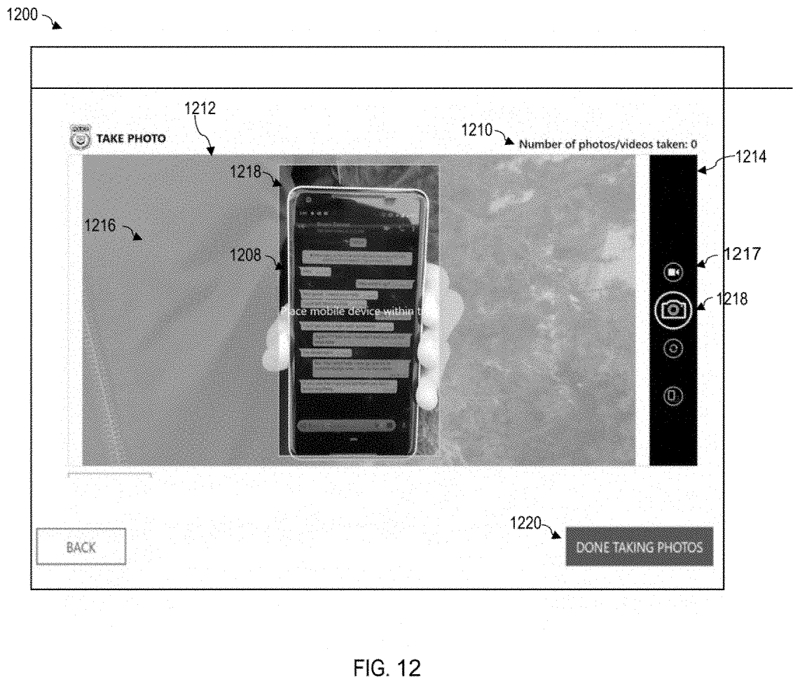

Referring now to FIG. 12, shown therein is a graphical interface 1200, according to an embodiment of the system 10.

The graphical interface 1200 may be launched and displayed upon receiving an evidence creator selection at 1110 of interface 1100 of FIG. 11. The interface 1200 may include or utilize a camera interface of the host device 12.

In an example, the graphical interface 1200 may be used to capture a photo of an evidence provider device 1208 displaying a chat or instant messaging interface (or other interface of the device). This may allow the user to collect, via the host device 12, digital evidence of an exchange without having to take possession of the provider device 16. In fact, the graphical interface 1200 may allow the evidence provider to maintain possession of the device by holding the device himself/herself.

At 1210, the interface 1200 displays a number of photos/videos taken using the interface 1200.

The interface 1200 includes a visualization area 1212 and an option tab 1214. The capture visualization area 1212 displays a real-time visualization of the field of view of the camera being used to capture the photo or video. The option tab 1214 includes a plurality of selectable icons that, when selected, perform certain functions of the camera interface.

The visualization area 1212 includes an unfocused area 1216 and a focused capture area 1218. The areas 1216, 1218 may make it easier for a user to capture an image.

An evidence provider can hold the provider device 16 in the focused capture area 1218.

The options tab 1214 includes a video capture icon 1217 and a photo capture icon 1218. By selecting the icons 1217, 1218, the camera of the host device 16 captures a video or photo, respectively. The captured photos or video are stored by the system as evidence item data (e.g. evidence item data 326 of FIG. 3).

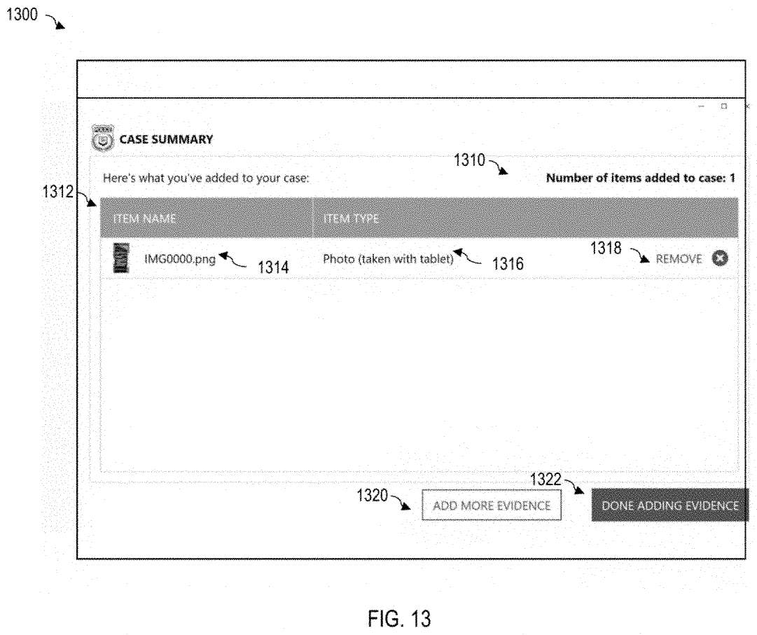

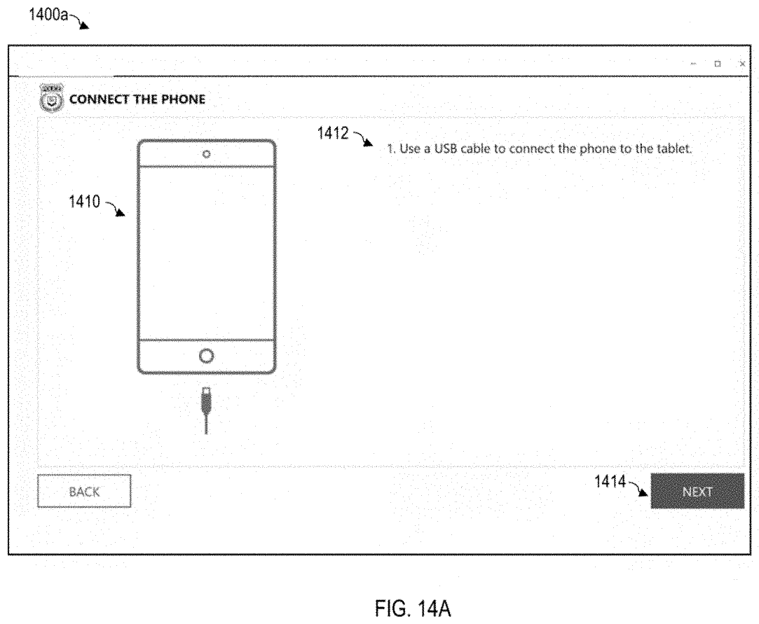

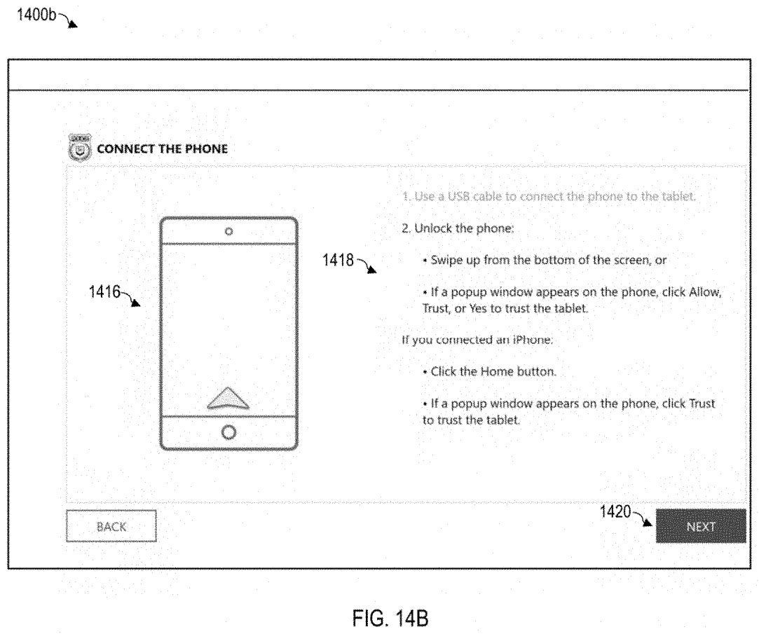

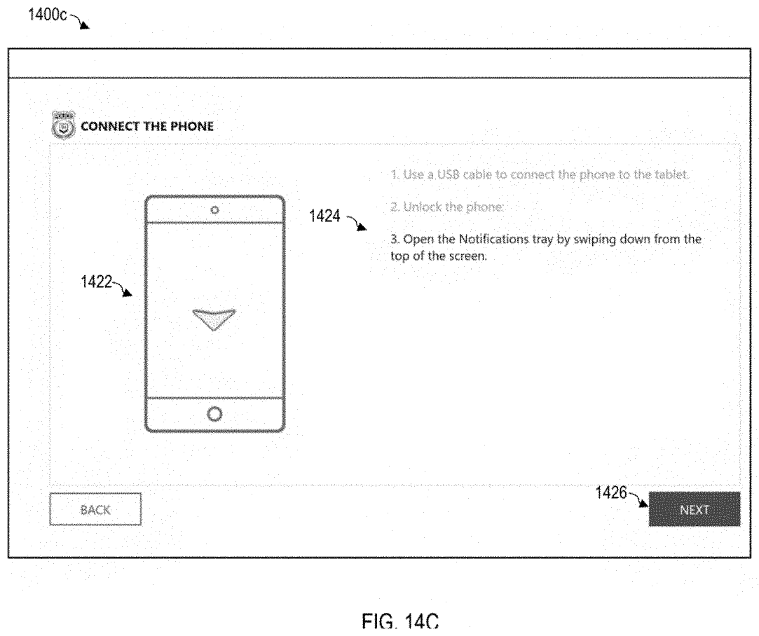

At 1220, the user can select a “done taking photos” icon which may cause the system 10 to launch and display a case summary interface displaying information about the evidence items collected (e.g. interface 1300 of FIG. 13, described below).

Referring now to FIG. 13, shown therein is a graphical interface 1300, according to an embodiment of the system 10.

The graphical interface 1300 implements a case summary interface. The case summary interface may display digital evidence items captured by the system and options for managing digital evidence items for a case.

In an example, the interface 1300 is a case summary interface displaying an evidence item collected using the graphical interface 1200 of FIG. 12.

At 1310, the interface 1300 displays a number of evidence items added to the case.

At 1312, the interface 1300 displays evidence item data for evidence items added to the case. The evidence item data is stored by the system. The evidence item data may be presented in a table format.

The displayed evidence item data 1312 includes item name data 1314 and item type data 1316 for the evidence item.

The item name data 1314 includes a name for the item, which may be a file name such as IMG0000.png.

The item type data 1316 includes an item type. The item type may be a photo or a video. The item type data 1316 may also include an item source describing the source of the item (e.g. “taken with tablet” or “taken with host device”). In some cases, the item source may be displayed separately from the item type data 1316.

At 1318, the user can select a “remove” icon which removes (i.e. deletes) the item from the case. This may cause the graphical interface 1300 to re-render itself in an updated version without the removed evidence item.

At 1320, the user can select an “add more evidence” icon to add additional evidence items to the case. The selection of the icon at 1320 may cause the system 10 to launch and display the capture method selection interface 1100 of FIG. 11.

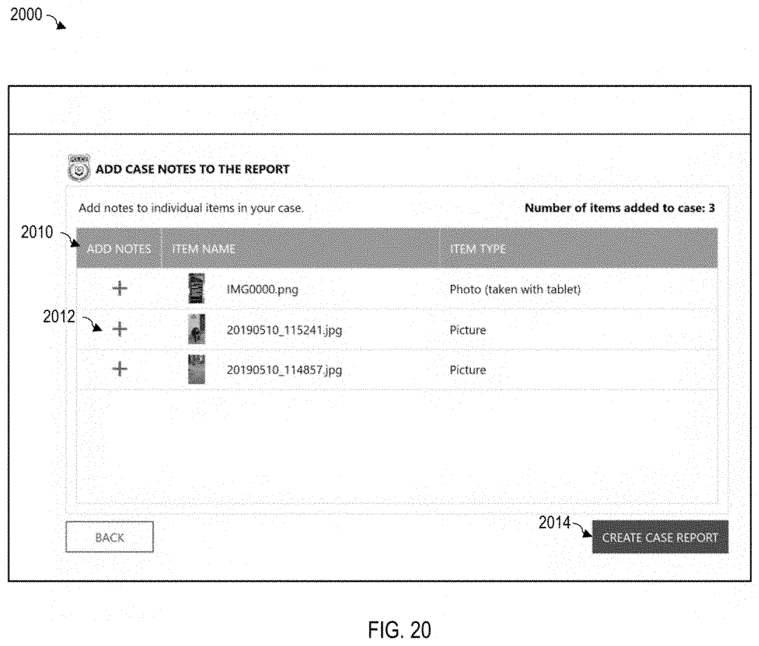

At 1322, the user can select a “done adding evidence” selection. The selection of the icon at 1322 may cause the system 10 to launch and display a case note interface for adding a case note, such as graphical interface 2000 of FIG. 20 (described below).

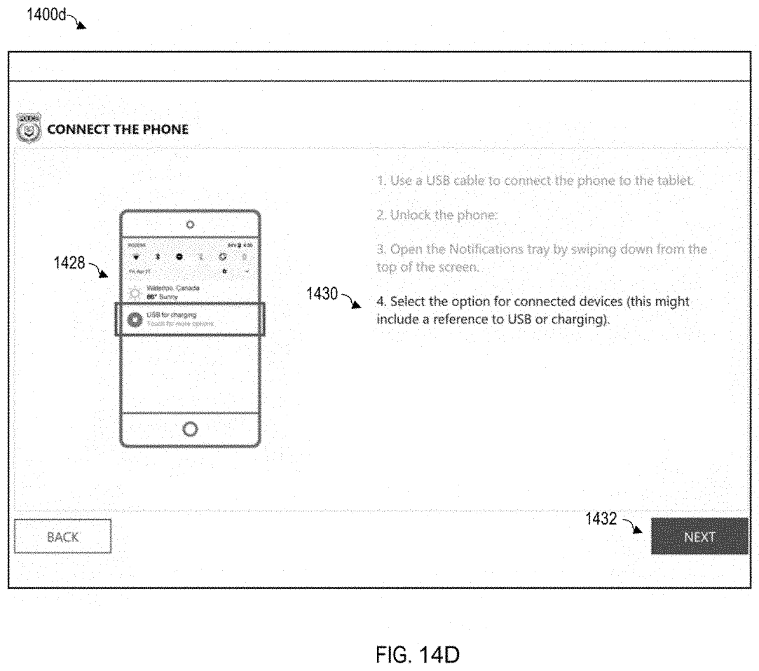

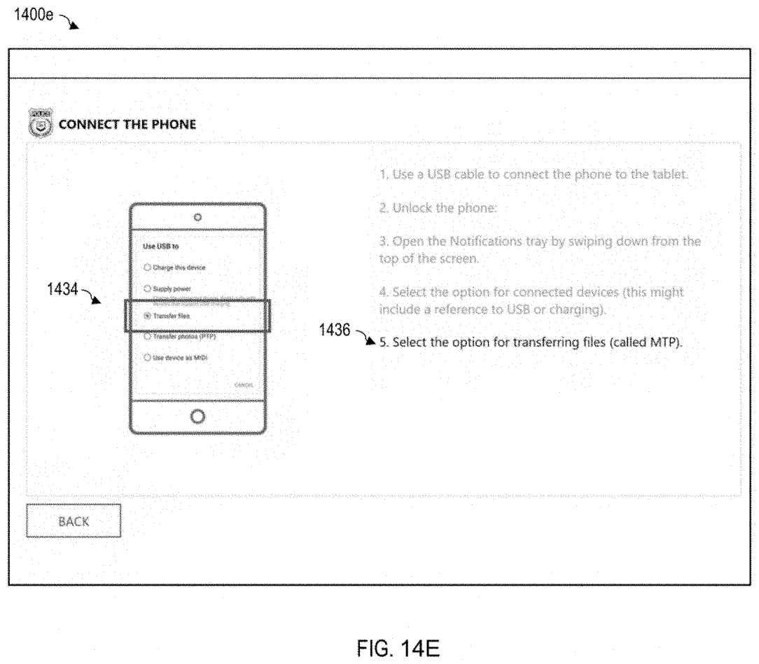

Referring now to FIGS. 14A to 14E, shown therein are graphical interfaces 1400a, 1400b, 1400c, 1400d, and 1400e, according to an embodiment of the system 10. The interfaces 1400a to 1400e are referred to collectively as interfaces 1400 and generically as interface 1400.

The interfaces 1400 display instructions for connecting a provider device 16 to the host device 12. The interfaces 1400 may be displayed in a stepwise manner by the system 10, where a subsequent step in the instruction sequence is not displayed until the previous step is detected by the system 10 to have been completed.

The interface 1400 may be launched and displayed by the system 10 after receiving a digital evidence transfer selection at 1112 of interface 1100 of FIG. 11.

FIG. 14A shows interface 1400a, which includes a visualization 1410 of a first connection instruction. The first connection instruction is displayed in text form at 1412. The first connection instruction describes a process for physically connecting the provider device 16 to the host device, such as via a USB cable.

At 1414, the user can select a “next” icon to move to the next step of the connection process.

FIG. 14B shows interface 1400b, which includes a visualization 1416 of a second connection instruction. The second connection instruction is displayed in text form at 1418. The second connection instruction describes a process for unlocking the provider device. The unlocking instruction may include instructions for multiple types of devices (e.g. android phone, iPhone).

At 1420, the user can select a “next” icon to move to the next step of the connection process.

FIG. 14C shows interface 1400c, which includes a visualization 1422 of a third connection instruction. The third connection instruction is displayed in text form at 1424. The third connection instruction describes a process for opening notifications on the provider device 16.

At 1426, the user can select a “next” icon to move to the next step of the connection process.

FIG. 14D shows interface 1400d, which includes a visualization 1428 of a fourth connection instruction. The fourth connection instruction is displayed in text form at 1430. The fourth connection instruction describes a process for selecting an option for connected devices on the provider device 16.

At 1432, the user can select a “next” icon to move to the next step of the connection process.

FIG. 14E shows interface 1400e, which includes a visualization 1434 of a fifth connection instruction. The fifth connection instruction is displayed in text form at 1436. The fifth connection instruction describes a process for selecting an option for transferring files. Selecting the option may facilitate transfer of files from the provider device 16 to the host device 12 via the MTP protocol.

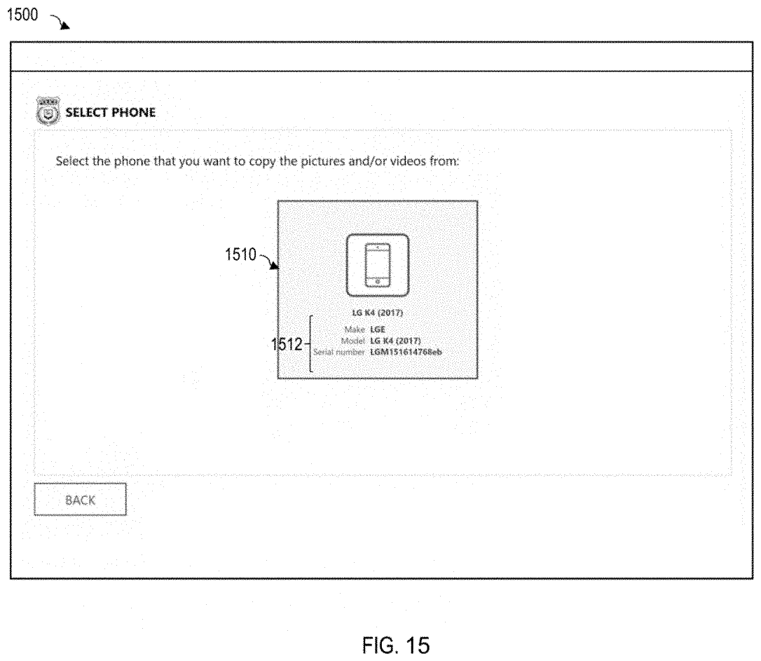

Referring now to FIG. 15, shown therein is a graphical interface 1500, according to an embodiment of the system 10.

The interface 1500 includes a provider device selection interface. Using the interface 1500, the user can select (confirm) the device from which files are to be transferred.

At 1510, the user can select a provider device from which to copy files to the host device 12.

The provider device icon at 1510 displays provider device data 1512. The provider device data 1512 may be retrieved from the connected provider device 16. The provider device data 1512 may include any one or more of a name, make, model, and serial number.

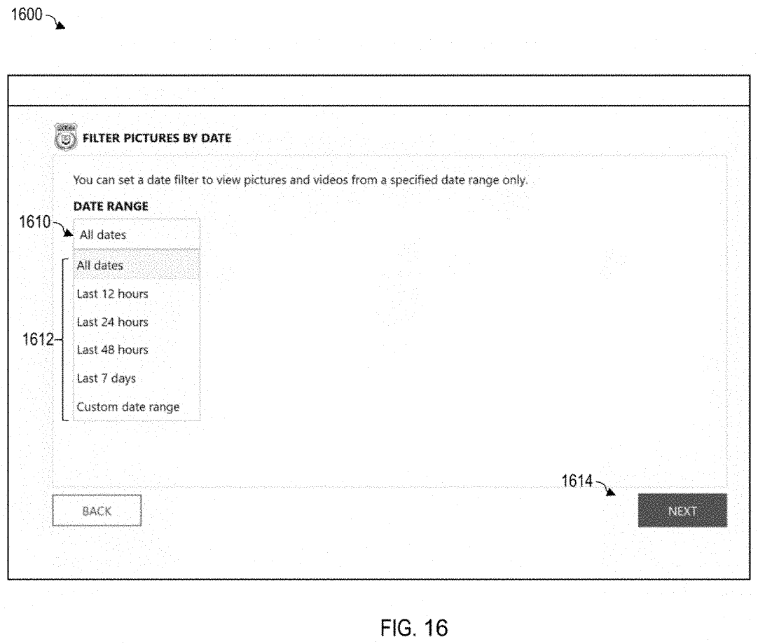

Upon selecting the device at 1510, the system 10 may launch and display a filter interface, such as graphical interface 1600 of FIG. 16 described below.

Referring now to FIG. 16, shown therein is a graphical interface 1600, according to an embodiment of the system 10.

The graphical interface 1600 implements a filter interface for filtering media data on the provider device 16. Using the interface 1600, the user can provide a filtering criterion.

At 1610, the user can input and the system receives filter criterion data via a filter data input field. The filter criterion data may include a date range. The filter criterion data is used by the system 10 to filter out media data on the provider device 16 that does not match the filter criterion.

At 1612, upon selecting the input field at 1610, the interface 1600 displays a drop-down menu of filter criterion options. Filter criterion options may include, for example, all dates, last 12 hours, last 24 hours, last 48 hours, last 7 days, and custom date range. The user can select a filter criterion option which populates the input field at 1610. Selecting a custom date range option may cause the system to launch another interface, for example as a popup window, for the user to input custom date range data.

At 1614, the user can select a “next” icon, which submits the filter criterion data to the system 10. Upon receiving the filter criterion data, the system 10 may run a filter module configured to filter media files on the provider device 16 according to the received filter criterion data.

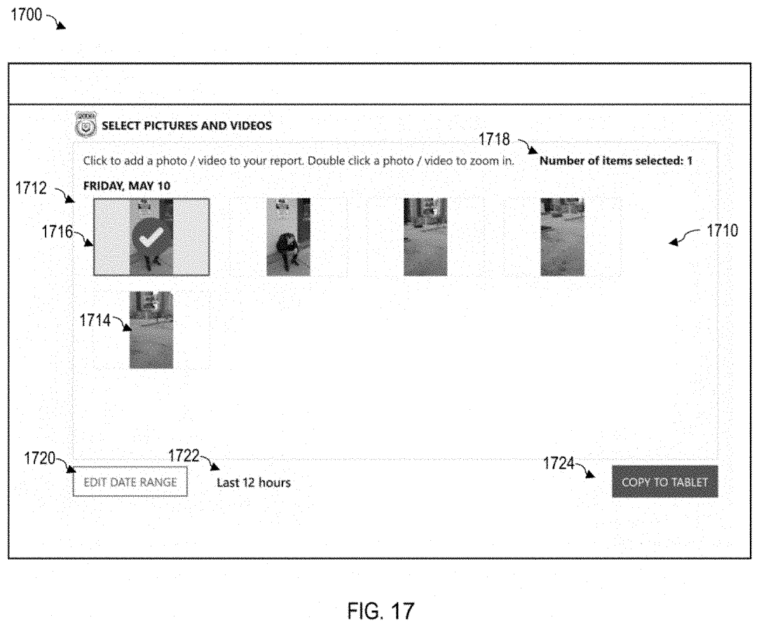

Referring now to FIG. 17, shown therein is a graphical interface 1700, according to an embodiment of the system 10.

The graphical interface 1700 may be displayed after interface 1600 of FIG. 16. The interface 1700 displays filtered media data from the provider device 16 and allows a user to select among filtered media data those files that the user wishes to add to the case (and copy to the system). The system may receive the user selections and copy provider device files to the host device 16 based on the selections.

At 1710, the interface displays filtered media data. The filtered media data includes a plurality of media files from the provider device 16 that meet the filter criterion input at interface 1600 of FIG. 16.

The displayed filtered media data includes date data 1712.

The interface 1700 displays the filtered media data as a plurality of thumbnail images 1714, with each thumbnail image corresponding to a filtered-in media file.

The thumbnail image 1714 may be a selectable icon. When the user selects the thumbnail image 1714 (e.g. by clicking on the icon), an overlay 1716 is provided over the thumbnail 1714 to indicate the file has been selected. In variations, the presentation of the thumbnail 1714 may change in other ways to indicate its selection by the user. By double-clicking the thumbnail image 1714, the picture may expand for display or, in the case of a video, the video may play in the interface.

The system 10 may store selected items as selected item data.

At 1718, the interface 1700 displays a number of items selected. The number 1718 is updated when an item 1714 is selected by the user.

At 1720, the user can select an “edit date range” icon. Selecting the icon at 1720 may return the user to the interface 1600 of FIG. 16 or may provide a date range selection as a popup window or dropdown menu in the interface 1700.

At 1722, the interface 1700 displays the filter criterion (date range) used to filter the media files.

At 1724, the user can select a “copy to tablet” icon, which copies the selected files 1716 to the host device 12. Upon selecting the icon 1724, the system 10 may use the stored selected item data to identify and copy selected files.

The copied files are stored on the host device 12 as evidence item data.

Selecting the icon at 1724 may cause the system 10 to launch and display a case summary interface displaying evidence item data about evidence items added to the case.

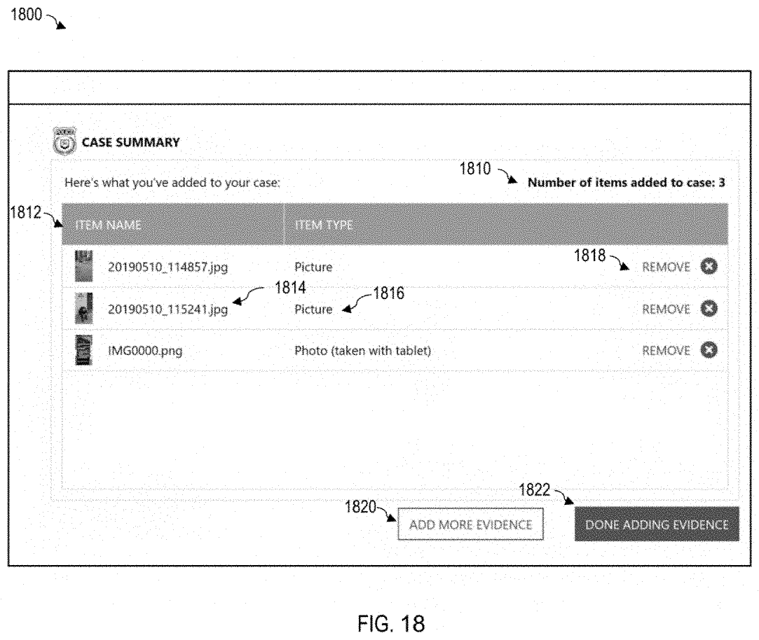

Referring now to FIG. 18, shown therein is a graphical interface 1800, according to an embodiment of the system 10.

The interface 1800 may be displayed by the system after the interface 1700 of FIG. 17 and display the evidence items added to the case (i.e. copied to the host device 16) using the interface 1700.

The interface 1800 may be an updated version of the graphical interface 1300 of FIG. 13, displaying evidence item data for evidence items added using the interface 1700 of FIG. 17.

At 1810, the interface 1800 displays a number of evidence items added to the case.

At 1812, the interface 1800 displays evidence item data for evidence items added to the case. The evidence item data is stored by the system 10. The evidence item data may be presented in a table format.

The displayed evidence item data 1812 includes item name data 1814 and item type data 1816 for the evidence item.

The item name data 1814 includes a name for the item, which may be a file name.

The item type data 1816 includes an item type. The item type may be a photo or a video. The item type data 1816 may also include an item source describing the source of the item (e.g. “provider device”). In some cases, the item source may be displayed separately from the item type data 1816.

At 1818, the user can select a “remove” icon which removes (i.e. deletes) the item from the case. This may cause the graphical interface 1800 to re-render itself in an updated version without the removed evidence item.

At 1820, the user can select an “add more evidence” icon to add additional evidence items to the case. The selection of the icon at 1820 may cause the system 10 to launch and display the capture method selection interface 1100 of FIG. 11.

At 1822, the user can select a “done adding evidence” selection. The selection of the icon at 1822 may cause the system 10 to launch and display a case note interface for adding a case note, such as graphical interface 2000 of FIG. 20 (described below).

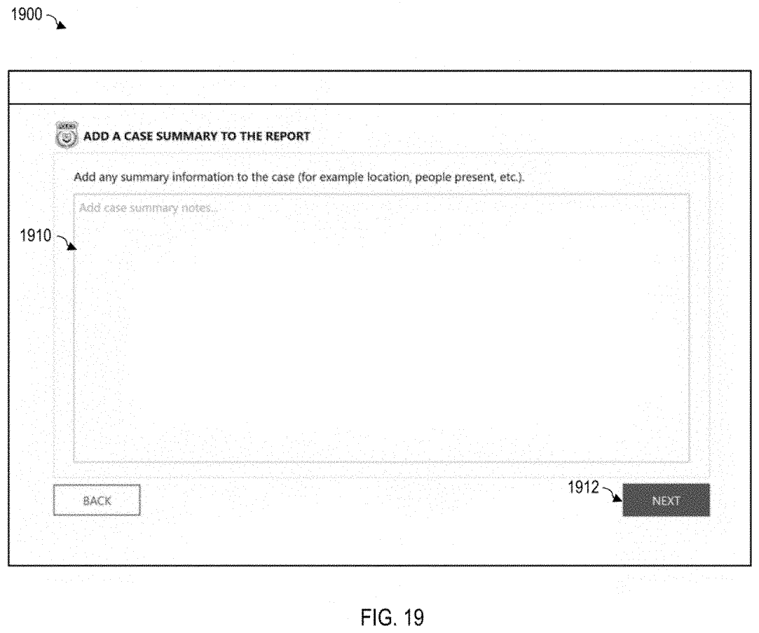

Referring now to FIG. 19, shown therein is a graphical interface 1900, according to an embodiment of the system 10.

The graphical interface 1900 implements a case annotator interface. The case annotator interface can be used to add one or more case notes to the case, which can be stored by the system 10 as case data for the case.

At 1910, the user can input and the system receives case note data. The input field at 1910 may be receptive to a text input. For example, the user may click on or select the input field 1910 and type in a case note.

The case note data may include a written note providing context or additional descriptive information about the incident giving rise to the case.

At 1912, the user can select a “next” icon, which submits the inputted case note data to the system 10. Selection of the icon 1912 may cause the system 10 to launch and display an item note interface, such as graphical interface 2000 of FIG. 20 (described below).

Referring now to FIG. 20, shown therein is a graphical interface 2000, according to an embodiment of the system 10.

The interface 2000 can be used to open an item note interface for adding item notes.

The interface 2000 displays evidence item data for each of the evidence items added to the case. The displayed evidence item data includes an item name and an item type.

The interface 2000 may display evidence item data in a manner similar to case summary interfaces 1300 and 1800 of FIGS. 13 and 18, respectively, with an additional column 2010 for adding an item note to the evidence item.

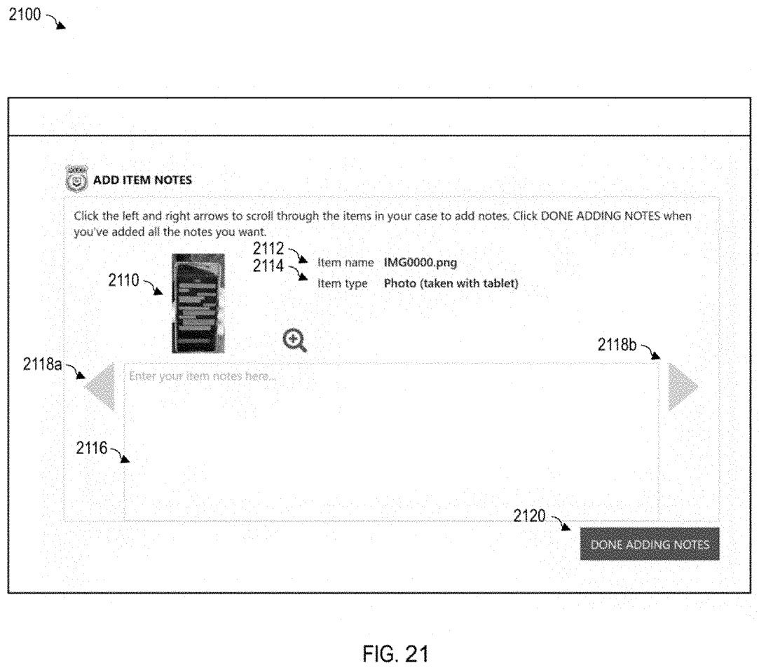

At 2012, the user can select an icon to add an item note to a particular evidence item in the system 10. Selecting the icon 2012 may cause the system to launch and display an item note interface, such as graphical interface 2100 of FIG. 21, described below.

At 2014, the user can select a “create evidence report” icon, which causes the system to generate a case report using the stored case data (including evidence item data).

Referring now to FIG. 21, shown therein is a graphical interface 2100, according to an embodiment of the system 10.

The graphical interface 2100 implements an item annotation interface for adding an item note to an evidence item stored by the system 10.

The interface 2100 displays various evidence item data including a thumbnail 2110, an item name 2112, and an item type 2114. The displayed evidence item data may remind the user which evidence item is being annotated.

At 2116, the user can input and the system receives item note data via an item note input field. The input field may be an input field configured to receive a text input. The item note data may be a written note providing context or descriptive information about the evidence item. The item note data may be stored by the system 10 as evidence item data.

At 2118a and 2118b, the user can navigate through the evidence items within the interface 2100 to add item notes to other evidence items.

At 2120, the user can select a “done adding notes” icon, which submits the item note data inputted at 2116 to the system 10.

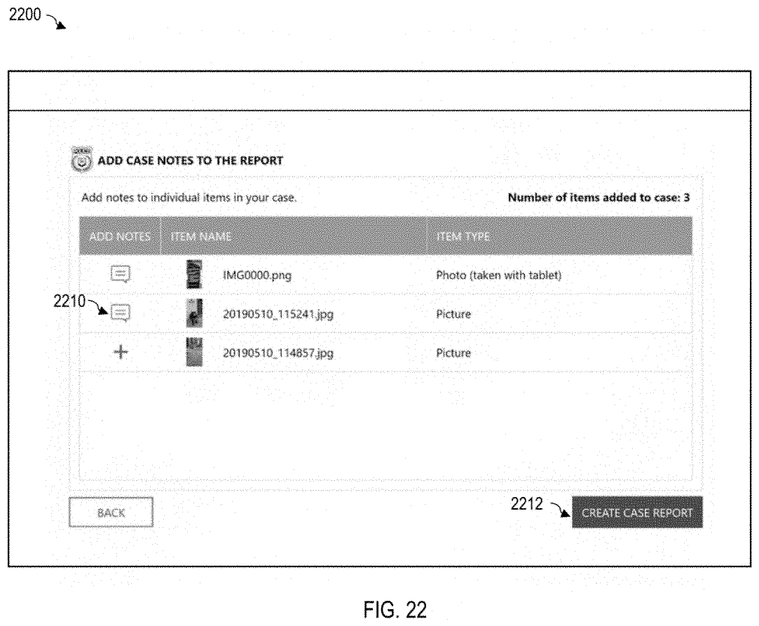

Selecting the icon 2120 may cause the system 10 to launch and display an updated version of the interface 2000 of FIG. 20 shown in FIG. 22.

FIG. 22 shows interface 2200 which is an updated version of the interface 2000 of FIG. 20. The interface illustrates via note icon 2210 that a note has been added for the evidence item.

At 2212, the user can select the “create evidence report” icon to generate a case report.

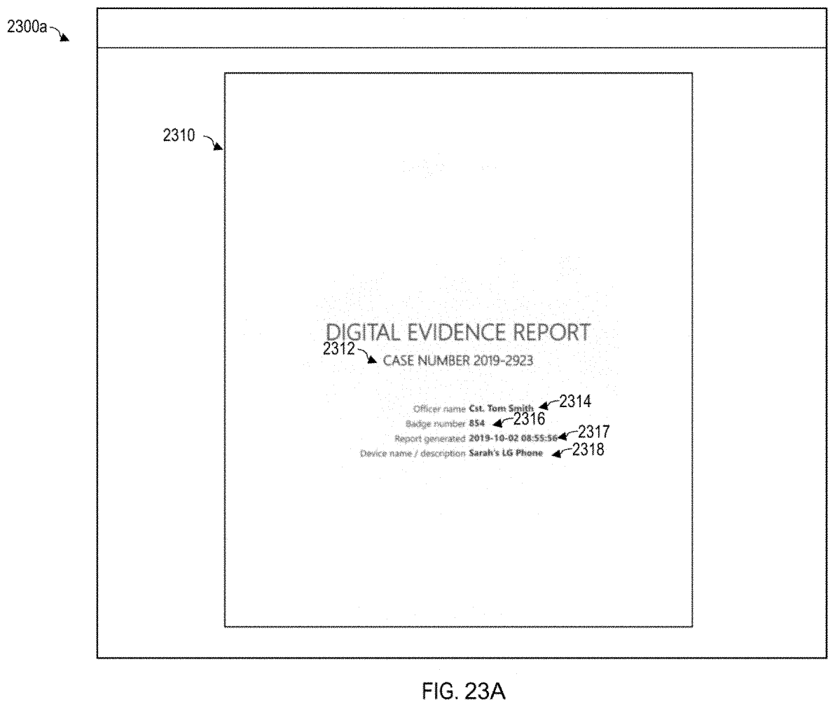

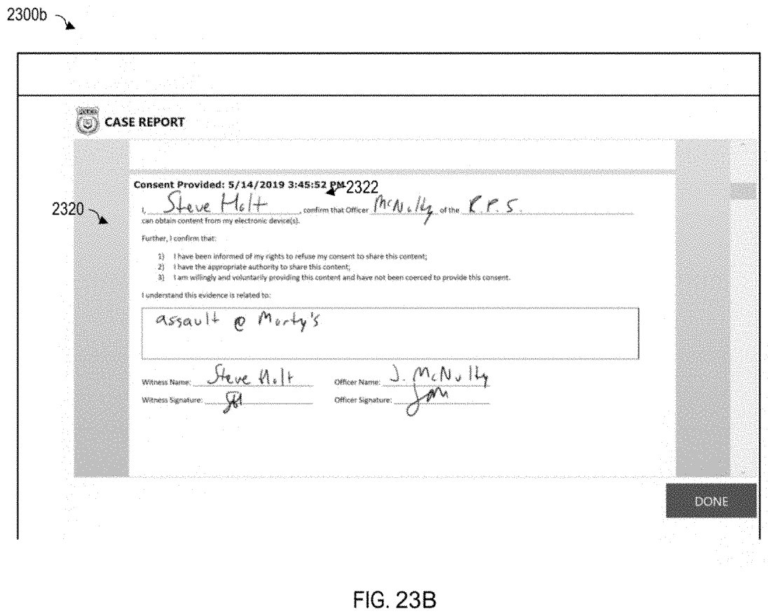

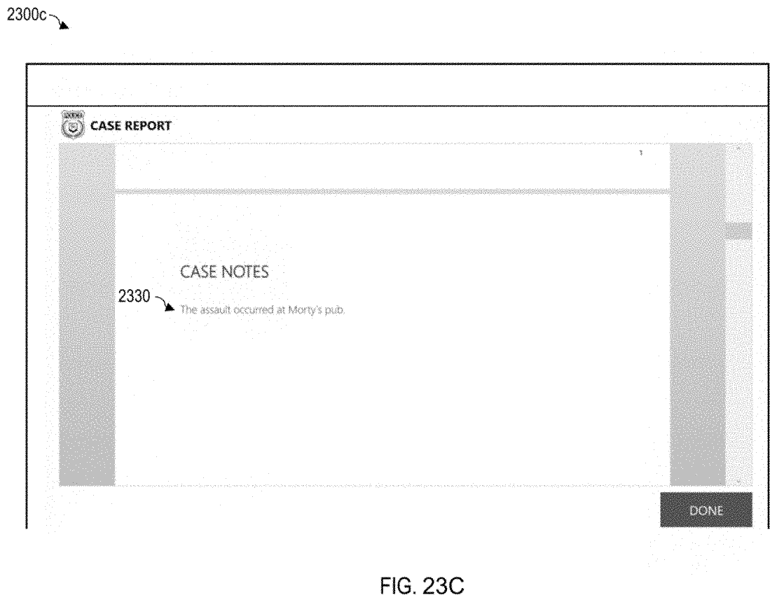

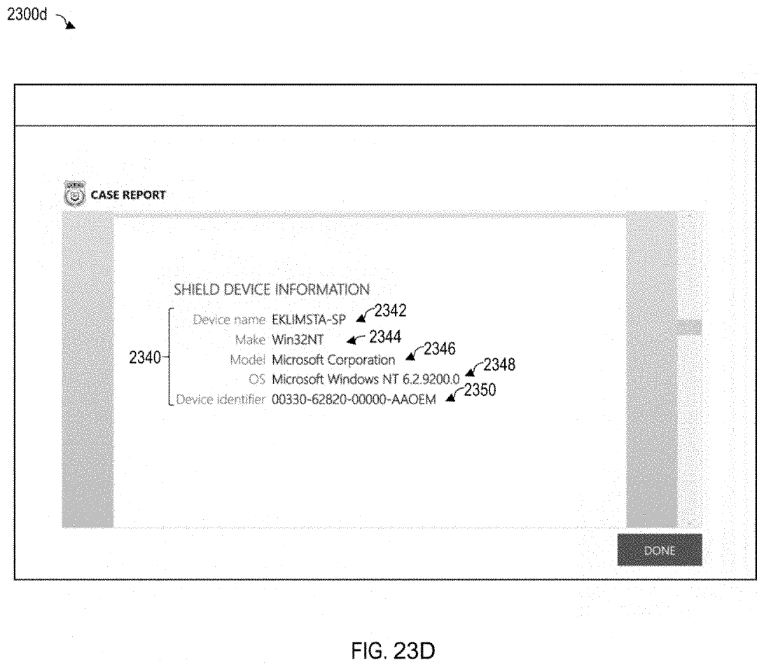

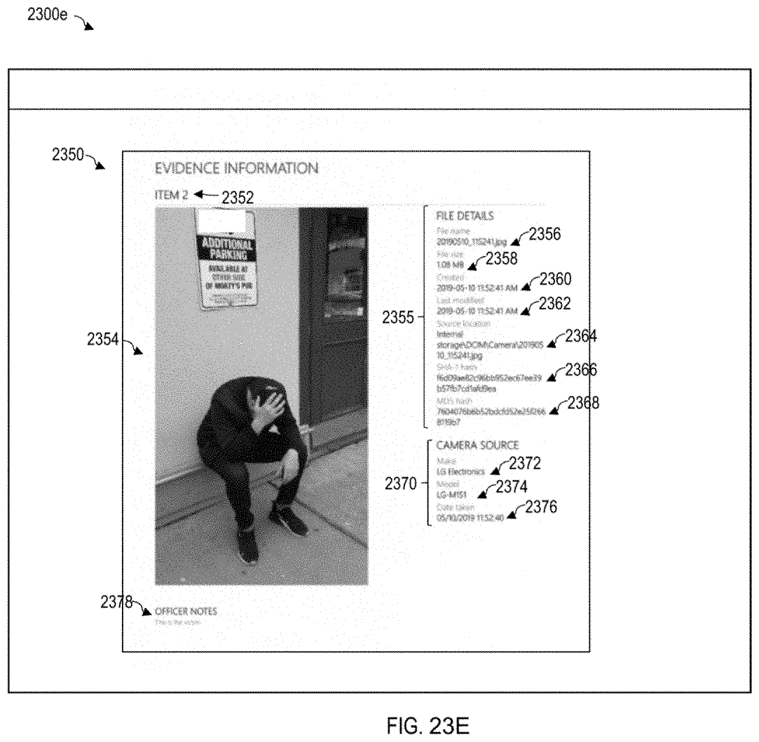

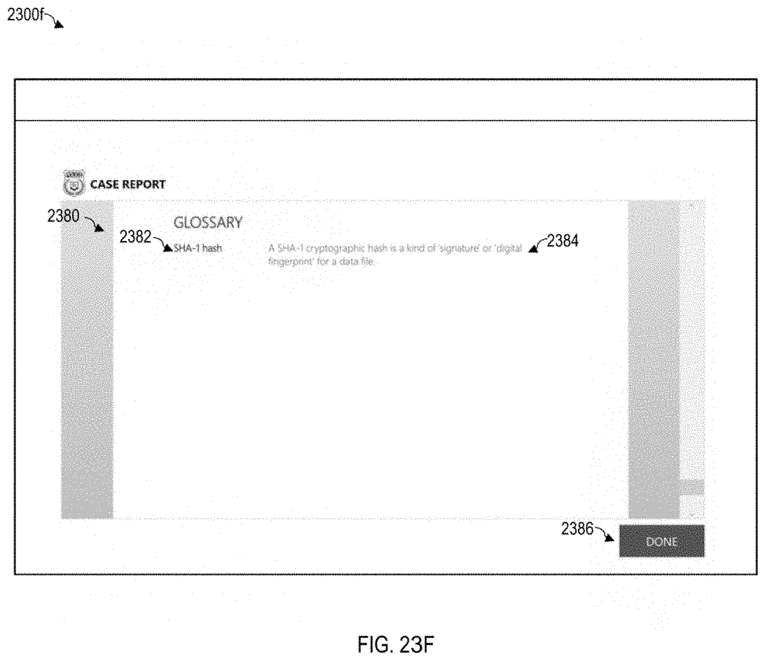

Referring now to FIGS. 23A to 23F, shown therein are graphical interfaces 2300a, 2300b, 2300c, 2300d, 2300e, 2300f, according to an embodiment of the system 10. The interfaces 2300a to 2300f are referred to collectively as interfaces 2300 and generically as interface 2300.

The interfaces 2300 implement a case report interface. The case report interface displays the electronic case report generated by the system 10. The case report may have been just generated by the system 10 or may have been generated during a previous session.

The system 10 may generate the case report upon receiving an input instruction to create the report (e.g. selecting icon 2212 of FIG. 22). The report may be generated using a PDF generation library and may utilize the case report template data and case data stored by the system 10.

The interfaces 2300 show a case report displayed in a scrollable format, with each interface 2300 showing a different component of the case report.

FIG. 23A shows graphical interface 2300a displaying a report title page 2310.

The report title page 2310 includes various case data includes case number data 2312, officer name data 2314, officer badge number data 2316, report generation time data 2317, and device name data 2318 (which is the provider device or devices 16).

FIG. 23B shows graphical interface 2300b displaying consent data 2320. The consent data 2320 may have been obtained using the graphical interface 900 of FIG. 9.

The consent data includes the consent form template filled with the input data received via the consent interface.

The interface 2300b also includes consent timestamp data 2322. The system 10 captures and stores the consent timestamp data 2322 when the consent data (e.g. the filled consent form) is submitted to the system 10.

FIG. 23C shows graphical interface 2300c displaying case note data 2330. The case note data 2330 may be received and stored by the system 10.

FIG. 23D shows graphical interface 2300d displaying host device data 2340. The host device data 2340 includes information about the host device 16 and is stored by the system 10.

The host device data 2340 includes a device name, a make, a model, an operating system (OS), and a device identifier.

FIG. 23E shows graphical interface 2300e displaying evidence item data 2350. The evidence item data 2350 is stored by the system 10.

The evidence item data 2350 includes an item name 2352.

The evidence item data 2350 includes an item image 2354. The item image 2354 may be a visual representation of the evidence item media file sized to fit the report.

The evidence item data 2350 includes file data 2356. The file data 2356 includes metadata for the evidence item (media file).

The file data 2355 includes file name data 2356, file size data 2358, file creation timestamp data 2360, last modified timestamp data 2362, source location data 2364, first hash data 2366 (e.g. SHA-1 hash value), and second hash data 2368 (e.g. MD5 hash value).

The evidence item data 2350 includes camera source data 2370.

The camera source data 2370 includes camera make data 2372, camera model data 2374, and timestamp data 2376. The timestamp data 2376 includes a date taken timestamp for the evidence item.

The evidence item data 2350 also includes item note data 2378.

FIG. 23F shows graphical interface 2300f displaying report glossary data 2380. The report glossary data includes a term 2382 and a corresponding definition 2384. The report glossary data 2380 may be a subset of glossary data that is stored by the system 10. In some cases, the report generator module may be configured to search the report for terms which are present in the glossary data and generate the report glossary data 2380 therefrom, which may limit the report glossary data 2380 to those terms present in the report.

At 2386, the user can select a “done” icon, which closes the report display interface 2300 and may launch and display a case management interface.

Referring now to FIG. 24, shown therein is a graphical interface 2400, according to an embodiment of the system 10.

The graphical interface 2400 implements a case management interface. The case management interface allows a user to view existing cases and perform various functions on the case data.

The interface 2400 displays a number of cases at 2410.

The graphical interface 2400 displays case data 2412 for a plurality of cases. The cases may be cases linked to a particular user account in the system 10. The case data 2412 is stored by the system 10 and may be presented in table format.

The case data 2412 includes case number data 2414, creation date data 2416, officer name data 2418, and case status data 2420.

The interface 2400 includes a checkbox 2422 for each case. The checkbox 2422 is configured to receive case selection data input by the user which can be stored by the system 10 and which identifies a given case as selected. In variations, the case may be selected using other techniques.

At 2424, the user can select a “select all cases” icon which automatically designates all cases as selected in the system 10.

At 2426, the user can select a “remove” icon which may cause the system 10 to delete case data for all selected cases. Such case data may be deleted from the host device 12.

At 2428, the user can select a “copy to USB key” icon which may cause the system 10 to implement a workflow for copying selected cases to an external storage or to copy the selected cases to an external storage device.

At 2430, the user can select an “open report” icon which may cause the system 10 to display the case report for the selected case. The system 10 may display the case report using the graphical interfaces 2300 of FIG. 23.

The graphical interface 2400 may be launched and displayed after graphical interface 2300 of FIGS. 23A-F, for example after closing the report display interface.

The graphical interface 2400 may be launched and displayed upon logging into the digital evidence application 316. In such a case, the interface 2400 may be displayed prior to graphical interface 800 of FIG. 8. To facilitate this, the interface 2400 may also include a “new case” icon (not shown) that, when selected by a user, takes the user to the interface 800 of FIG. 8 to input data for a new case.

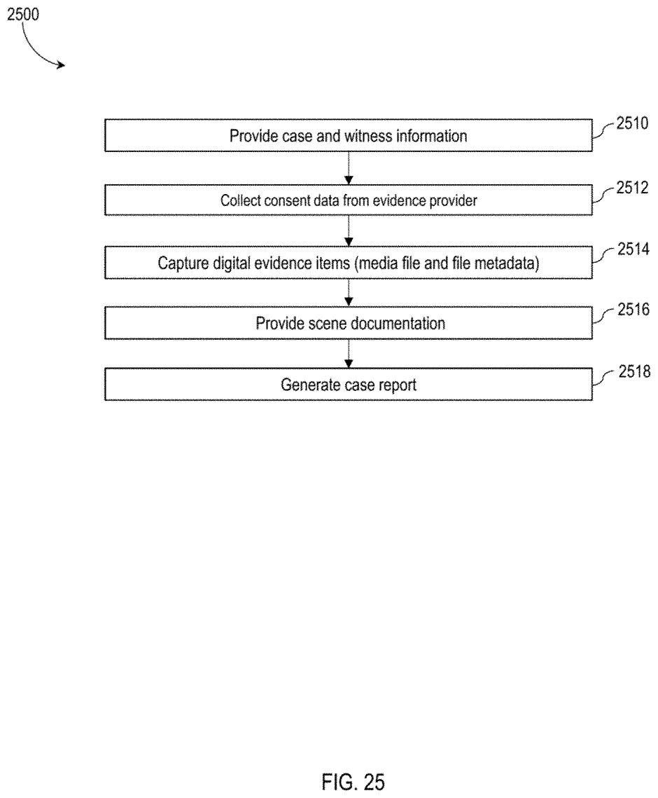

Referring now to FIG. 25, shown therein is a digital evidence processing workflow 2500, according to an embodiment. The workflow 2500 can be used to capture, manage, and report on digital evidence infield. The workflow 2500 may be implemented by an infield digital evidence management system, such as systems 10 and 300 of FIGS. 1 and 3, respectively. The workflow 2500 may be implemented in a plurality of software modules comprising computer executable instructions that, when executed by a processor of the digital evidence management system, cause the system to perform the functionalities of the workflow 2500.

In an embodiment, the workflow 2500 may be implemented by the host device 12 of FIG. 1.

At 2510, case and witness information is provided to the system. The system receives the case and witness information via a user interface. The case and witness information may be input by a user at a user interface running on the host device 12. The case information includes identifying data identifying a case for which digital evidence is to be added. The witness information includes identifying data identifying a witness who is to provide digital evidence to the system and for whom consent is to be obtained and stored by the system.

The case information may include a case number. The case information may also include an officer name and an officer badge number.

The witness information may include a witness name.

The input, receiving, and storage of case and witness information may be controlled by the case management module # of FIG. 3.

At 2514, consent is obtained using the system. The system receives consent data. The consent data may be input by a user at a user interface running on the host device 12. The consent data represents consent from the evidence provider to the collection and use of the digital evidence. The consent data may include any one or more of an electronic signature (e.g. text input, signing with a finger or stylus), audio of consent, or video of consent.

At 2518, digital evidence is captured using the system.

The system captures digital evidence from an evidence provider device (e.g. provider device 16 of FIG. 1). This includes connecting the provider device to the system, such as via the host device, such that the digital evidence can be transferred from the provider device to the system. Transferring the digital evidence may include copying one or more media files stored on the provider device.

The system may be configured to filter media data stored on the provider device according to a filtering criterion, such as a date range, to generate a first subset of the media data (i.e. the filtered data). The system may then display the first subset of provider media data in such a way that a user of the system can identify and select certain medial files to upload to the system as digital evidence items. The system may then copy the selected media files from the provider device to the system and store the copied files.

Also at 2518, the system may capture digital evidence (e.g. photos, video) of the scene directly, such as via a camera of the host device.

The digital evidence collected by the system may be stored in a forensically sound manner. This may include the collection of metadata of the evidence item. The evidence item metadata may include a hash value.

At 2522, the scene is documented using the system. The system receives scene documentation data. The scene documentation data may be provided by a user at a user interface running on the host device. The scene documentation data may include descriptive information about a case or a particular evidence item (e.g. a certain photo) that may provide additional context.

In an embodiment, the scene documentation data may be inputted as a text note via a text field using the host device.

At 2526, the system generates and stores an electronic case report. The electronic case report may be in a file format that provides an electronic image of text or text and graphics that looks like a printed document and can be viewed, printed, and electronically transmitted (e.g. PDF).

The case report includes the digital evidence items collected by the system including relevant metadata for each evidence item. The report also includes the scene documentation data.

The case report also includes the consent obtained from the evidence provider and the case and witness data.

The system may display the case report at a display of the host device when generated or when otherwise selected for display by the user.

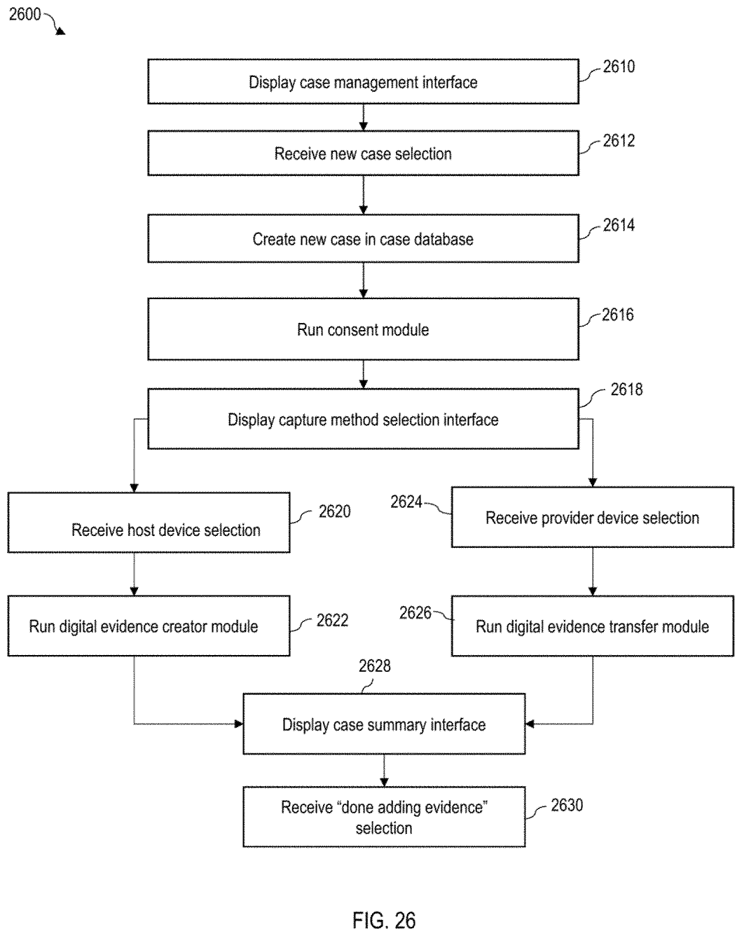

Referring now to FIGS. 26 to 32, shown therein are digital evidence workflows 2600, according to embodiments of the present disclosure. The workflows may be implemented by the digital evidence systems of the present disclosure. In particular, the workflows 2600 may be implemented by the computer system 300 of FIG. 3 as one or more software modules executable the processor 350 of FIG. 3.

Referring now to FIG. 26, shown therein is a workflow 2600, according to an embodiment. Workflow 2600 describes a first part of an overall infield digital evidence capture and reporting process which may be implemented by the digital evidence capture and reporting application 352 of FIG. 3.

At 2610, the system 300 displays a case management interface at display 306.

At 2612, the system 300 receives a “new case” selection. The new case selection is received from a user via the user input device 308.

At 2614, the case manager module 354 creates a new case in the case database 314.

At 2616, the system 300 runs the consent module 356. The consent module 356 implements a consent capture process.

At 2618, the system 300 displays a capture method selection interface for selecting an evidence capture method at display 306.

At 2620, the system 300 receives a host device selection via the user input device 308.

At 2622, the system 300 runs the digital evidence creator module 362 in response to receiving the host device selection at 2120.

At 2624, the system 300 receives a provider device selection via the user input device 308.

At 2626, the system 300 runs the digital evidence transfer module 364 in response to receiving the provider device selection at 2624.

At 2628, the system 300 displays a case summary interface via the display 306. The case summary interface 306 displays evidence items added to a given case via steps 2622 and 2626.

At 2630, the system 300 receives a “done adding evidence” selection via the user input device 308.

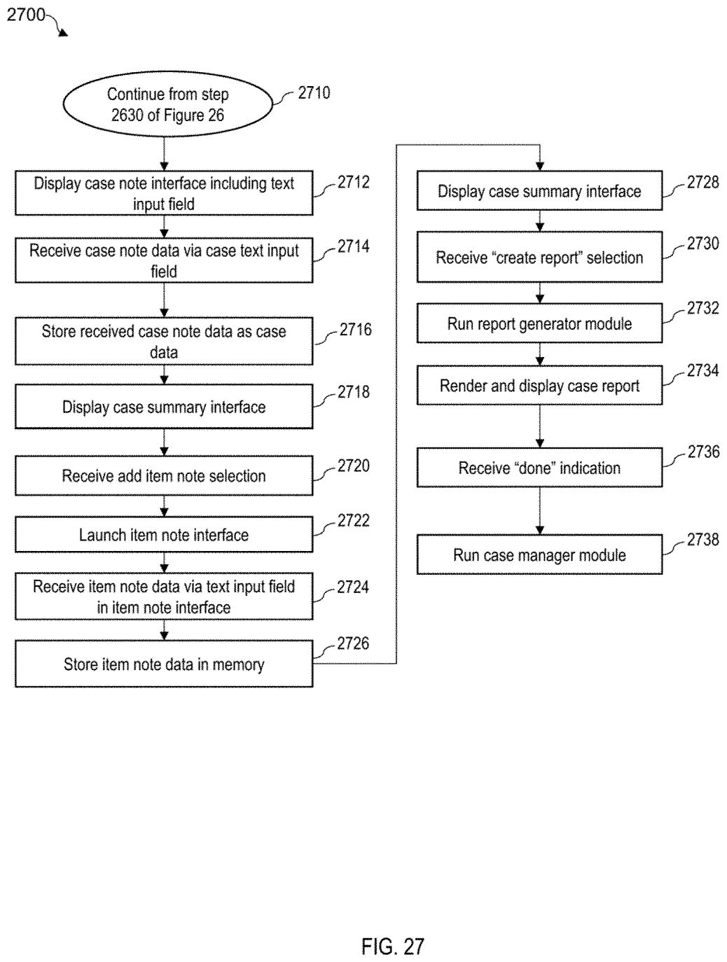

Referring now to FIG. 27, shown therein is a workflow 2700, according to an embodiment. Workflow 2700 is a continuation of workflow 2600, following step 2630. Workflow 2700 describes a second part of an overall infield digital evidence capture and reporting process which may be implemented by the digital evidence capture and reporting application 352 of FIG. 3.

At 2710, the workflow 2700 continues from step 2630 of FIG. 26.

At 2712, the system 300 displays a case note interface. The case note interface includes a text input field for receiving case note data. The case note interface is displayed via the display 306.

At 2714, the system 300 receives case note data via text input received at the text input field via the user input device 308.

At 2716, the system 300 stores the received case note data in memory 310.

At 2718, the system 300 displays a case summary interface. The case summary interface displays a subset of case data 316 for cases linked to an account.

At 2720, the system 300 receives an add item note selection via the input device 308.

At 2722, the system 300 launches an item note interface. The item note interface is displayed via the display 306.

At 2724, the system 300 receives item note data via a text input field of the item note interface. The item note data is received via the user input device 308.

At 2726, the system 300 stores the received item note data in memory 310.

At 2728, the system 300 displays a case summary interface. The case summary interface displays the evidence items that have been added to a given case. The case summary interface is displayed via the display 306.

At 2730, the system 300 receives a “create report” selection via the case summary interface. The selection is provided via the user input device 308.

At 2732, the system 300 runs the report generator module 370. The report generator module 370 generates case report data 349.

At 2734, the system 300 renders and displays the case report data 349 via the report display module 372. The case report is displayed via the display 306.

At 2736, the system 300 receives a “done” indication. The done indication is provided by a user via the user input device 308.

At 2738, the system 300 runs the case manager module 354 and displays the case management interface at display 306.

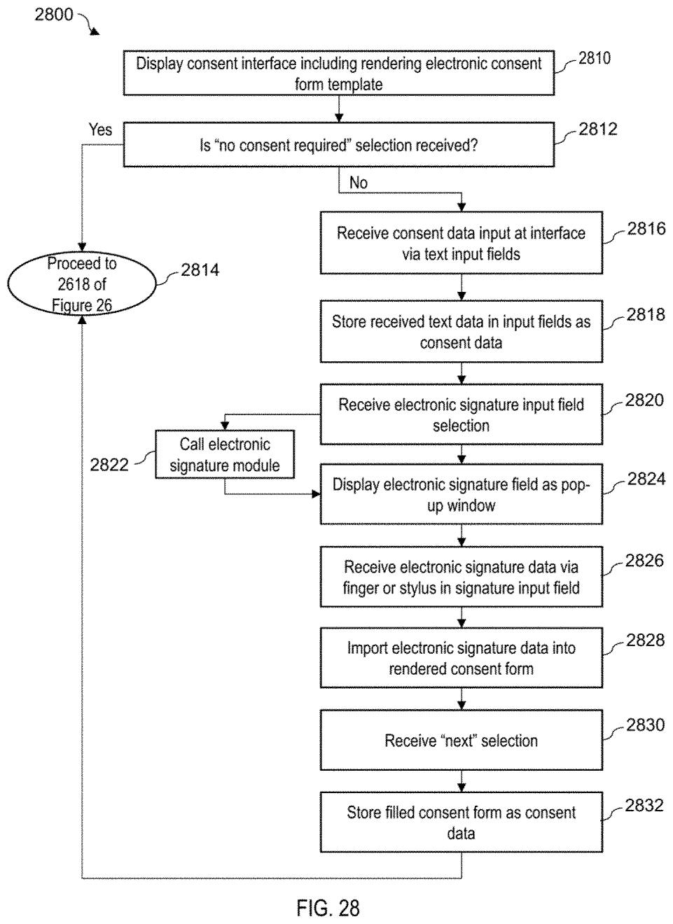

Referring now to FIG. 28, shown therein is a workflow 2800, according to an embodiment. The workflow 2800 describes a consent capture process which may be implemented by the consent module 356 of FIG. 3.

The workflow 2800 may be initiated by the system 300 at step 2616 of FIG. 26.

At 2810, the system 300 displays a consent interface via the display 306. The consent interface includes a rendered consent form template 325.

At 2812, the system 300 determines whether a “no consent required” selection has been received via the consent interface.

At 2814, if no consent is required, the system 300 proceeds to step 2618 of FIG. 26.

At 2816, if consent is required, the system 300 receives a text input via the user input device 308 at one or more text input fields.

At 2818, the text input data is stored as consent data 324.

At 2820, the system 300 receives an electronic signature field selection via the user input device 308. This may include tapping the electronic signature field displayed in the consent interface.

At 2822, the system 300 runs an electronic signature module configured to acquire electronic signature data via a touchscreen interface.

At 2824, the system 300 displays the electronic signature field as a pop-up window in the consent interface.

At 2826, the system 300 receives electronic signature data via the electronic signature field. The signature data may be provided via finger or stylus device.

At 2828, the system 300 imports the received electronic signature data into the consent form displayed in the consent interface.

At 2830, the system 300 receives a “next” selection via the user input device 308.

At 2832, the system 300 stores the filled consent form as consent data 324 in memory 310.

The workflow 2800 then proceeds to 2814, and the system 300 proceeds to step 2618 of FIG. 26.

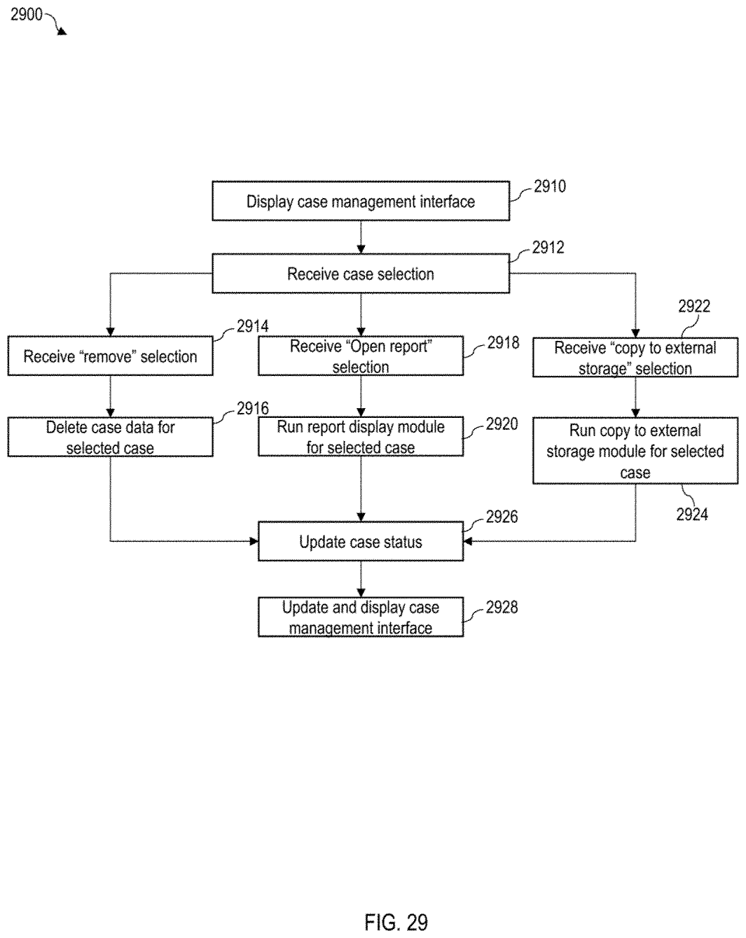

Referring now to FIG. 29, shown therein is a workflow 2900, according to an embodiment. The workflow 2900 describes a case management process which may be implemented by the case manager module 354 of FIG. 3.

At 2910, the system 300 displays the case management interface via the display 306.

At 2912, the system 300 receives a case selection via the user input device 308. The case selection marks a particular case for subsequent action by the system 300.

At 2914, the system 300 receives a “remove” selection via the user input device 308.

At 2916, in response to receiving the remove selection, the system 300 deletes case data 316 for the selected case.

At 2918, the system 300 receives an “open report” selection via the user input device 308.

At 2920, in response to receiving the open report selection, the system 300 runs the report display module 372, which displays the case report data 349 for the selected case via the display 306.

At 2922, the system 300 receives a “copy to external storage” selection via the user input device 308.

At 2924, the system runs a copy to external storage module configured to copy case data 316 for the selected case to the external storage device.

At 2926, the system 300 updates a case status for the selected case according to the action chosen by the user.

At 2928, the system 300 updates and displays the case management interface via the display 306 using the updated case status from 2926.

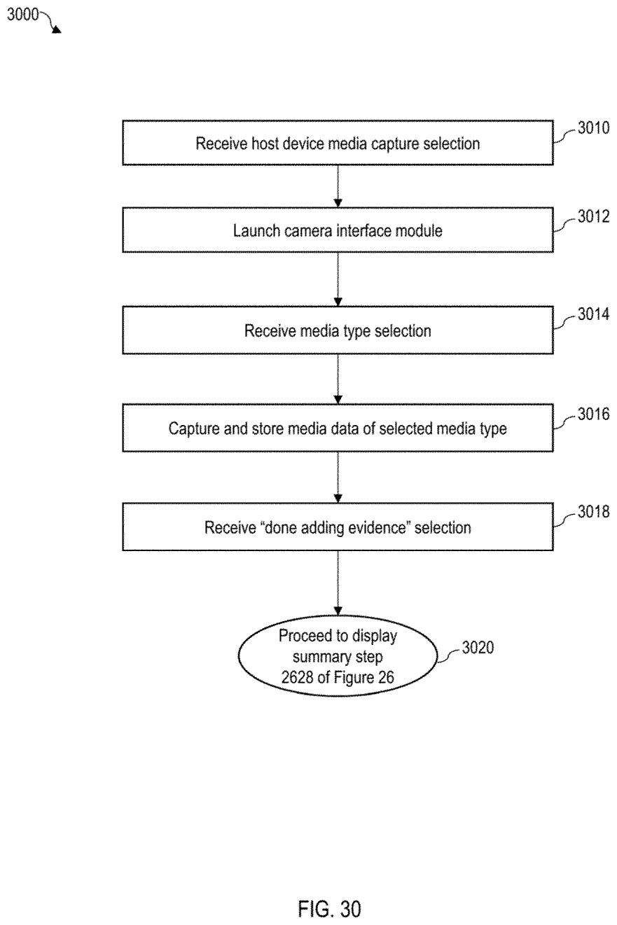

Referring now to FIG. 30, shown therein is a workflow 3000, according to an embodiment. The workflow 3000 describes a digital evidence capture process which may be implemented by the digital evidence creation module 362 of FIG. 3.

At 3010, the system 300 receives a host device media capture selection via the user input device 308.

At 3012, the system 300 launches a camera interface module configured to implement a camera interface on the device 12 for capturing images, audio, or video.

At 3014, the system 300 receives a media type selection via the user input device 308. The media type selection may be, for example, photo or video.

At 3016, the system 300 captures media data of the selected media type and stored the media file 328 (and related metadata 330) in memory 310.

At 3018, the system 300 receives a “done adding evidence” selection via the user input device 308.

At 3020, in response to receiving the selection at 3018, the system 300 proceeds to step 2628 of FIG. 26.

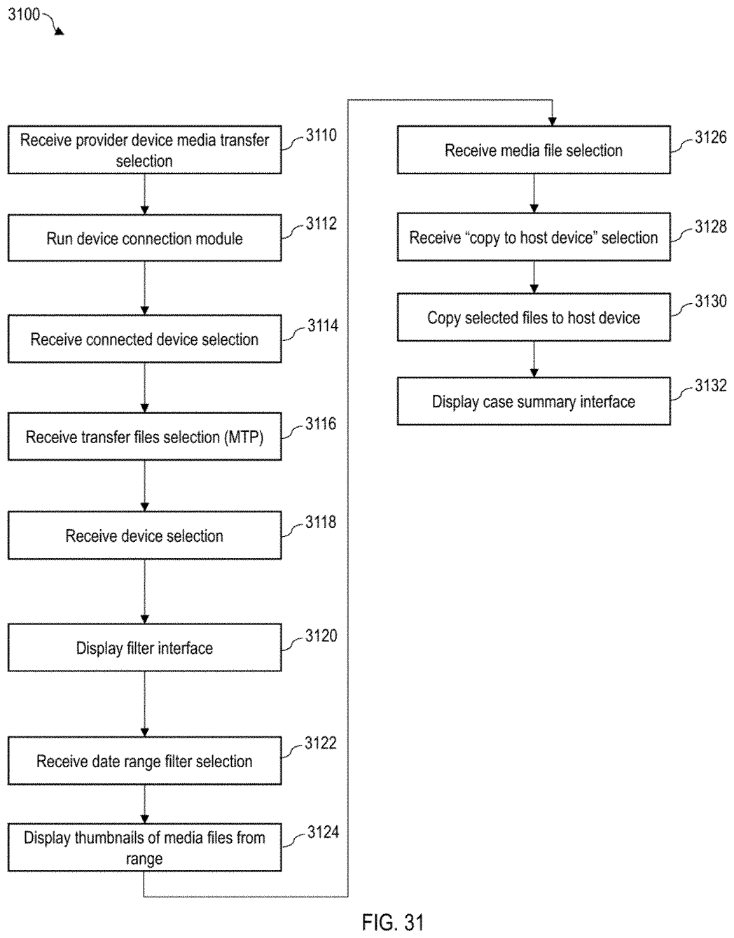

Referring now to FIG. 31, shown therein is a workflow 3100, according to an embodiment. The workflow 3100 describes a digital evidence transfer process which may be implemented by the digital evidence transfer module 364 of FIG. 3.

At 3110, the system 300 receives a provider device media transfer selection via the user input device 308 indicating the intention of the user to transfer digital evidence from a provider device to the host device 12.

At 3112, the system 300 runs a device connection module configured to connect the provider device 16 to the host device 12 and instruct the user through the connection process.

At 3114, the system 300 receives a connected device selection via the user input device 308. The connected device selection may be a USB connected device.

At 3116, the system 300 receives a “transfer files” selection via the user input device 308. The transfer files selection initiates a transfer of files from the provider device 16 via MTP.

At 3118, the system 300 receive a device selection via the user input device 308. The device selection may confirm the device from which files are to be transferred by the system 300.

At 3120, the system 300 displays a media filtering interface via the display 306.

At 3122, the system 300 receives a date range filter selection via the user input device 308.

At 3124, the system 300 displays thumbnails of media files from the provider device 16 from the specified filter range via the display 306.

At 3126, the system 300 receives a media file selection via the user input device 308.

At 3128, the system 300 receives a “copy to host device” selection via the user input device 308.

At 3130, the system 300 copies the media files selected at 3128 onto the host device and stores them as evidence item data 324 in memory 310.

At 3132, the system 300 displays a case summary interface at display 306. The case summary interface displays information about the media files copied to the host device 12.

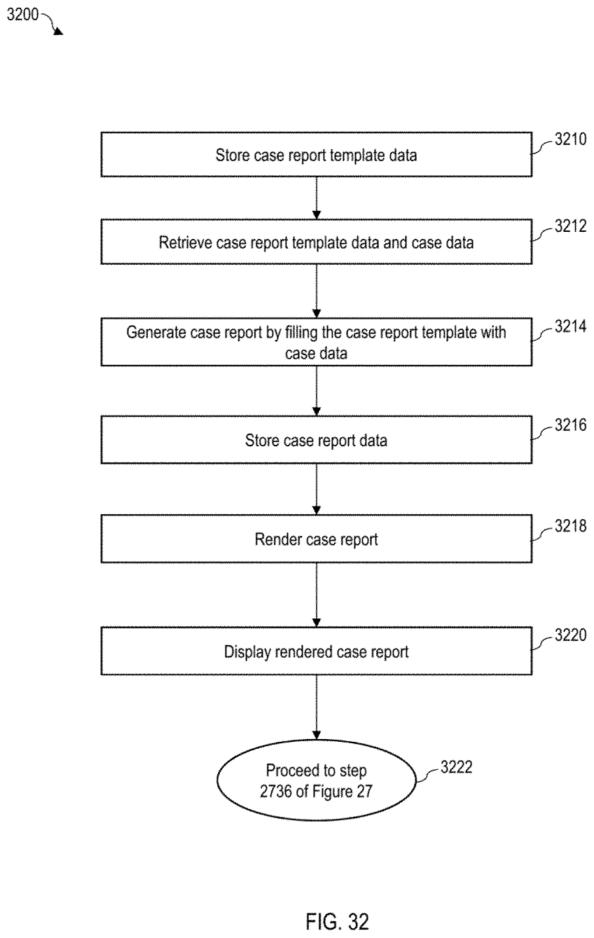

Referring now to FIG. 32, shown therein is a workflow 3200, according to an embodiment. The workflow 3200 describes a case report generation process which may be implemented by the case report generator module 370 and case report display module 372 of FIG. 3.

At 3210, the system 300 stores case report template data 348 in memory 310.

At 3212, the system 300 retrieves the case report template data 348 and case data 316 for a selected case.

At 3214, the system 300 generates case report data 349 by filling the case report template with case data 316 for the selected case.

At 3216, the system 300 stores the case report data 349 in memory 310.

At 3218, the system 300 renders the case report.

At 3220, the system 300 displays the rendered case report via the display 306.

At 3222, the system 300 proceeds to step 2736 of FIG. 27.

While the above description provides examples of one or more apparatus, methods, or systems, it will be appreciated that other apparatus, methods, or systems may be within the scope of the claims as interpreted by one of skill in the art.

1. A computer system for infield collection of digital evidence, the computer system comprising:
a communication interface for communicatively connecting the computer system to an evidence provider device, the evidence provider device associated with an evidence provider;
a processor communicatively connected to the communication interface and configured to transfer digital evidence from the evidence provider device to the computer system by:
pulling a plurality of media files from the evidence provider device onto the computer system;
filtering the plurality of media files according to filtering criterion data;
displaying a thumbnail of each of the filtered media files;
receiving selection data indicating which of the displayed filtered media files is selected to be transferred; and
copying the selected media files and media file metadata for the selected media files to the computer system;
a user input device communicatively connected to the processor and configured to receive the filtering criterion data and selection data from a user; and
a display communicatively connected to the processor and configured to display at least one output of the processor.

2. The computer system of claim 1, wherein the computer system is a host device comprising a mobile computing device.

3. The computer system of claim 1, wherein the computer system includes a host device comprising a mobile computing device communicatively connected to a remote server in a client-server relationship.

4. The computer system of claim 1, wherein the processor pulls the selected media files and media file metadata data from the provider device via the Media Transfer Protocol.

5. The computer system of claim 1, wherein the media file metadata includes forensic data.

6. The computer system of claim 5, wherein the forensic data includes any one or more of a hash value and an original file path. The computer system of claim 1, wherein the media file metadata includes EXIF data.

8. The computer system of claim 7, wherein the EXIF data includes any one or more of geolocation data and a timestamp.

9. The computer system of claim 1, wherein the processor is further configured to capture consent data from the evidence provider prior to transferring the digital evidence.

10. The computer system of claim 9, wherein the consent data includes audio data or video data captured by a camera of the computer system.

11. The computer system of claim 9, wherein the consent data includes a filled electronic consent form including electronic signature data provided by the evidence provider.

12. The computer system of claim 1, wherein the evidence provider device connects to the computer system via a USB On-The-Go format.

13. The computer system of claim 2, wherein the provider device connects to the host device via a USB cable.

14. The computer system of claim 1, wherein the provider device connects to the computer system via a WiFi direct hotspot hosted by the computer system.

15. The system of claim 1, wherein the provider device connects to the host device via an external website provided by the computer system, and wherein the external website is configured to perform a cloud-based transfer of the digital evidence.

16. The system of claim 1, wherein the processor is further configured to generate an electronic case report describing the transferred digital evidence and including at least a portion of the media file metadata.

17. A method of collecting and reporting on digital evidence, the method comprising:
Connecting an evidence provider device to a host device;
transferring digital evidence from the evidence provider device to the host device by:
pulling a plurality of media files from the evidence provider device onto the host device;
filtering the plurality of media files according to filtering criterion data;
displaying a thumbnail of each of the filtered media files;
receiving selection data indicating which of the displayed filtered media files is selected to be transferred; and
copying the selected media files and media file metadata for the selected media files to the host device; and
generating an electronic case report describing the transferred digital evidence and including at least a portion of the media file metadata.

18. The method of claim 17, further comprising capturing consent data from the evidence provider via the computer system.

19. The method of claim 18, wherein the consent data includes one or more of audio data, video data, and a filled electronic consent form including electronic signature data provided by the evidence provider.

20. The method of claim 17, wherein the media file metadata includes any one or more of a hash value, an original file path, geolocation data, and a timestamp.
